(19) United States
(12) Patent Application Publication
(10) Pub. No.: US 2019/0024729 A1
(43) Pub. Date: Jan. 24, 2019

(54) MACHINING DEVICE AND MACHINING METHOD

(71) Applicant: JTEKT CORPORATION, Osaka-shi (JP)

(72) Inventors: Lin Zhang, Nagoya-shi (JP); Hisashi Otani, Anjo-shi (JP); Hiroyuki Nakano, Tokai-shi (JP)

(73) Assignee: JTEKT CORPORATION, Osaka-shi (JP)

(21) Appl. No.: 16/039,873

(22) Filed: Jul. 19, 2018

(30) Foreign Application Priority Data
Jul. 21, 2017 (JP) 2017-142176
Jul. 21, 2017 (JP) 2017-142177

(51) Int. Cl. F16D 23/06; B23F 1/06

(52) U.S. Cl. CPC F16D 23/06; F16D 2023/0668; F16D 2023/0631; B23F 1/06

(57) ABSTRACT

To provide a machining device and a machining method that can achieve a reduction in a machining time of grooves of a workpiece including grooves having different torsion angles. A machining device includes a control device configured to use a machining tool having a rotation axis, an intersection angle of which can be changed with respect to a rotation axis of a workpiece, and cut a peripheral surface of the workpiece by feeding the machining tool relatively in a direction of the rotation axis of the workpiece while rotating the machining tool synchronously with the workpiece. The peripheral surface of the workpiece includes at least two grooves having torsion angles different from each other. The control device changes the intersection angle based on the torsion angles to respectively cut the at least two grooves.

### CROSS REFERENCE TO RELATED APPLICATIONS

This application claims priority based on Japanese Patent Application No. 2017-142176 filed on Jul. 21, 2017 and Japanese Patent Application No. 2017-142177 filed on Jul. 21, 2017, the entire contents of which are incorporated by reference herein.

### BACKGROUND OF THE INVENTION

### Technical Field

The present invention relates to a machining device and a machining method.

### Background Art

In transmissions used in vehicles, a synchromesh mechanism is provided to perform smooth gear shift operation. As illustrated in FIG. 28, a key-type synchromesh mechanism 110 includes a main shaft 111, a main drive shaft 112, a clutch hub 113, keys 114, a sleeve 115, a main drive gear 116, a clutch gear 117, and a synchronizer ring 118.

The main shaft 111 and the main drive shaft 112 are coaxially disposed. The clutch hub 113 is spline-fitted to the main shaft 111. The main shaft 111 and the clutch hub 113 rotate together. The keys 114 are supported by not-illustrated springs in three places of the outer circumference of the clutch hub 113. An inner tooth (a spline) 115a is formed on the inner circumference of the sleeve 115. The sleeve 115 slides together with the keys 114 in a direction of a rotation axis LL along a not-illustrated spline formed on the outer circumference of the clutch hub 113.

The main drive gear 116 is fitted to the main drive shaft 112. The clutch gear 117, from which a taper cone 117b is projected, is integrally formed on the sleeve 115 side of the main drive gear 116. The synchronizer ring 118 is disposed between the sleeve 115 and the clutch gear 117. An outer tooth 117a of the clutch gear 117 and an outer tooth 118a of the synchronizer ring 118 are formed to be meshable with the inner tooth 115a of the sleeve 115. The inner circumference of the synchronizer ring 118 is formed in a taper shape frictionally engageable with the outer circumference of the taper cone 117b.

The operation of the synchromesh mechanism 110 is described. As illustrated in FIG. 29A, the sleeve 115 and the keys 114 move in the direction of the rotation axis LL indicated by an arrow in FIG. 29A according to operation of a not-illustrated shift lever. The keys 114 push the synchronizer ring 118 in the direction of the rotation axis LL and press the inner circumference of the synchronizer ring 118 against the outer circumference of the taper cone 117b. Consequently, the clutch gear 117, the synchronizer ring 118, and the sleeve 115 start synchronized rotation.

As illustrated in FIG. 29B, the keys 114 are pushed down by the sleeve 115 and further press the synchronizer ring 118 in the direction of the rotation axis LL. Therefore, adhesion of the inner circumference of the synchronizer ring 118 and the outer circumference of the taper cone 117b increase. A strong frictional force is generated. The clutch gear 117, the synchronizer ring 118, and the sleeve 115 rotate synchronously with one another. When the rotating speed of the clutch gear 117 and the rotating speed of the sleeve 115 are completely synchronized, the frictional force of the inner circumferential surface of the synchronizer ring 118 and the outer circumference of the taper cone 117b disappears.

When the sleeve 115 and the keys 114 further move in the direction of the rotation axis LL indicated by an arrow in FIG. 28B, the keys 114 fit in a groove 118b of the synchronizer ring 118 and stop. However, the sleeve 115 moves climbing over convex sections 114a of the keys 114. The inner tooth 115a of the sleeve 115 meshes with the outer tooth 118a of the synchronizer ring 118. As illustrated in FIG. 29C, the sleeve 115 further moves in the direction of the rotation axis LL indicated by an arrow in FIG. 29C. The inner tooth 115a of the sleeve 115 meshes with the outer tooth 117a of the clutch gear 117. In this way, gear shift is completed.

In the synchromesh mechanism 110 described above, to prevent gear coming-off of the outer tooth 117a of the clutch gear 117 and the inner tooth 115a of the sleeve 115 during traveling, as illustrated in FIGS. 30 and 31, a taper-like gear-coming-off preventing section 120 is provided in the inner tooth 115a of the sleeve 115. Further, a not-illustrated taper-like gear-coming-off preventing section taper-fitting with the gear-coming-off preventing section 120 is provided in the outer tooth 117a of the clutch gear 117. In the following description, a side surface 115A on the left side in the figures of the inner tooth 115a of the sleeve 115 is referred to as left side surface 115A (equivalent to “side surface on one side” of the invention). A side surface 115B on the right side in the figures of the inner tooth 115a of the sleeve 115 is referred to as right side surface 115B (equivalent to “side surface on the other side” of the invention).

The left side surface 115A of the inner tooth 115a of the sleeve 115 includes a left tooth flank 115b (equivalent to “first tooth flank” of the invention) and a tooth flank 121 (hereinafter referred to as left tapered tooth flank 121; equivalent to “second tooth flank” of the invention) and a tooth flank 131 (hereinafter referred to as left chamfered tooth flank 131; equivalent to “third tooth flank” of the invention) having torsion angles different from a torsion angle of the left tooth flank 115b. The left tapered tooth flank 121 is formed to extend to the left chamfered tooth flank 131 on the end surface side of the inner tooth 115a. The right side surface 115B of the inner tooth 115a of the sleeve 115 includes aright tooth flank 115c (equivalent to “fourth tooth flank” of the invention) and a tooth flank 122 (hereinafter referred to as right tapered tooth flank 122; equivalent to “fifth tooth flank” of the invention) and a tooth flank 132 (hereinafter referred to as right chamfered tooth flank 132; equivalent to “sixth tooth flank” of the invention) having torsion angles different from a torsion angle of the right tooth flank 115c. The right tapered tooth flank 122 is formed to extend to the right chamfered tooth flank 132 on the end surface side of the inner tooth 115a.

In this example, the torsion angle of the left tooth flank 115b is 0 degree, the torsion angle of the left tapered tooth flank 121 is θf degrees, the torsion angle of the left chamfered tooth flank 131 is θL degrees, the torsion angle of the right tooth flank 115c is 0 degree, the torsion angle of the right tapered tooth flank 122 is θr degrees, and the torsion angle of the right chamfered tooth flank 132 is θR degrees. The left tapered tooth flank 121, a tooth flank 121a (hereinafter referred to as left sub-tooth flank 121a) and the left chamfered tooth flank 131 that connect the left tapered tooth flank 212 and the left tooth flank 115b, the right tapered tooth flank 122, and a tooth flank 122a (hereinafter referred to as right sub-tooth flank 122a) and the right chamfered tooth flank 132 that connect the right tapered tooth flank 122 and the right tooth flank 115c configure the gear-coming-off preventing section 120. The left tapered tooth flank 121 and the gear-coming-off preventing section of the clutch gear 117 taper-fit, whereby gear coming-off prevention is achieved. The left chamfered tooth flank 131 and the right chamfered tooth flank 132 are tooth flanks for smoothly performing meshing with the gear-coming-off preventing section of the clutch gear 117.

In this way, the structure of the inner tooth 115a of the sleeve 115 is complicated. The sleeve 115 is a component that needs to be mass-produced. Therefore, in general, the left tooth flank 115b and the right tooth flank 115c of the inner tooth 115a of the sleeve 115, that is, a groove between the left tooth flank 115b and the right tooth flank 115c (hereinafter simply referred to as “tooth groove 115g”; equivalent to “first tooth groove or second tooth groove” of the invention) is formed by broaching, gear shapering, or the like. The left tapered tooth flank 121 and the right tapered tooth flank 122 of the gear-coming-off preventing section 120, that is, a groove between the left tapered tooth flank 121 and the right tapered tooth flank 122 (hereinafter simply referred to as “left tapered tooth groove 121g”; equivalent to “first tooth groove or second tooth groove” of the invention, and referred to as “right tapered tooth groove 122g”; equivalent to “first tooth groove or second tooth groove” of the invention) is formed by rolling (see Japanese Utility Model Registration No. 2547999). The left chamfered tooth flank 131 and the right chamfered tooth flank 132 of the gear-coming-off preventing section 120, that is, a groove between the left chamfered tooth flank 131 and the right chamfered tooth flank 132 (hereinafter simply referred to as “left chamfered tooth groove 131g”; equivalent to “first tooth groove or second tooth groove” of the invention, and referred to as “right chamfered tooth groove 132g”; equivalent to “first tooth groove or second tooth groove” of the invention) is formed by end milling (see JP-A-2004-76837) or punching (see JP-B-3-55215).

As described above, the machining of the sleeve 115 includes various machining such as the broaching, the gear shapering, the rolling, the end milling, and the punching. To further improve machining accuracy, a process for removing burrs formed during the machining is necessary. Therefore, a machining time tends to be long.

### SUMMARY OF THE INVENTION

The invention has been devised in view of such circumstances, and an object of the invention is to provide a machining device and a machining method that can achieve a reduction in a machining time of grooves of a workpiece including grooves having different torsion angles.

A machining device of the invention is a machining device including a control device configured to use a machining tool having a rotation axis, an intersection angle of which can be changed with respect to a rotation axis of a workpiece and cut a peripheral surface of the workpiece by feeding the machining tool relatively in a direction of the rotation axis of the workpiece while rotating the machining tool synchronously with the workpiece. The peripheral surface of the workpiece includes at least a first groove and a second groove having torsion angles different from each other, and the control device changes the intersection angle based on the torsion angles to respectively cut the first groove and the second groove.

In the machining device according to the invention, because the grooves having the different torsion angles are formed by only the cutting, it is possible to more greatly reduce a machining time than in the past.

A machining method according to the invention is a machining method for using a machining tool having a rotation axis, an intersection angle of which can be changed with respect to a rotation axis of a workpiece and cutting a peripheral surface of the workpiece by feeding the machining tool relatively in a direction of the rotation axis of the workpiece while rotating the machining tool synchronously with the workpiece. A tooth of a gear having both side wall sections of a first groove and a second groove as tooth flanks is formed on the peripheral surface of the workpiece. A side surface on one side of the tooth of the gear includes a first tooth flank, a second tooth flank having a torsion angle different from a torsion angle of the first tooth flank, and a third tooth flank having a torsion angle different from the torsion angles of the first tooth flank and the second tooth flank and formed to extend to the second tooth flank further on an end surface side of the tooth of the gear than the second tooth flank. A side surface on the other side of the tooth of the gear includes a fourth tooth flank, a fifth tooth flank having a torsion angle different from a torsion angle of the fourth tooth flank, and a sixth tooth flank having a torsion angle different from the torsion angles of the fourth tooth flank and the fifth tooth flank and formed to extend to the fifth tooth flank further on the end surface side of the tooth of the gear than the fifth tooth flank.

The machining method includes: a step of first setting the intersection angle to a first intersection angle to at least roughly machine the first tooth flank and the fourth tooth flank; a step of subsequently changing the intersection angle to a second intersection angle to machine the third tooth flank and changing the intersection angle to a third intersection angle to machine the sixth tooth flank; a step of subsequently changing the intersection angle to a fourth intersection angle to machine the second tooth flank and changing the intersection angle to a fifth intersection angle to machine the fifth tooth flank; and a step of finally changing the intersection angle to the first intersection angle to finish the first tooth flank and the fourth tooth flank.

In the machining method of the invention, the tooth flanks having the different torsion angles are cut in order and formed. Therefore, burrs formed in the cuttings can be removed in order. Burrs formed last can be removed by finish-cutting. Therefore, it is unnecessary to separately provide a process for burr removal. It is possible to more greatly reduce a machining time than in the past.

### BRIEF DESCRIPTION OF DRAWINGS

FIG. 1 is a diagram illustrating an overall configuration of a machining device according to an embodiment of the invention;

FIG. 2 is a flowchart for describing a tool designing process for a tapered tooth flank machining tool by a control device in FIG. 1;

FIG. 3 is a flowchart for describing a tool designing process for a chamfered tooth flank machining tool by the control device illustrated in FIG. 1;

FIG. 4 is a flowchart for describing a tool state setting process by the control device illustrated in FIG. 1;

FIG. 5 is a flowchart for describing a machining control process for an inner tooth flank and a chamfered tooth flank by the control device illustrated in FIG. 1;

FIG. 6 is a flowchart following FIG. 5 for describing a machining control process for a tapered tooth flank and the inner tooth flank by the control device illustrated in FIG. 1;

FIG. 7 is a diagram illustrating torsion angles of the inner tooth flank, the tapered tooth flank, and the chamfered tooth flank, torsion angles of machining tools, and an intersection angle at the time when the tooth flanks are machined by the machining tools;

FIG. 8A is a diagram illustrating a schematic configuration of the machining tool viewed in a direction of a rotation axis from a tool end surface side;

FIG. 8B is a partial cross-sectional view illustrating a schematic configuration of the machining tool illustrated in FIG. 8A viewed in a radial direction;

FIG. 8C is an enlarged view of a cutting blade of the machining tool illustrated in FIG. 8B;

FIG. 9A is a diagram illustrating a dimensional relation between the machining tool and a workpiece when designing the tapered tooth flank machining tool when a left tapered tooth flank is machined;

FIG. 9B is a diagram illustrating a positional relation between the machining tool and the workpiece when designing the tapered tooth flank machining tool when the left tapered tooth flank is machined;

FIG. 9C is a diagram illustrating a dimensional relation between the machining tool and the workpiece when designing the tapered tooth flank machining tool when a right tapered tooth flank is machined;

FIG. 10 is a diagram illustrating respective portions of the machining tool used when calculating a cutting edge width and a blade thickness of the machining tool;

FIG. 11 is a diagram illustrating a schematic configuration of a machining tool for machining a tapered tooth flank viewed in the radial direction;

FIG. 12 is a diagram illustrating a schematic configuration of a cutting blade of a machining tool for machining a chamfered tooth flank viewed in an axial direction;

FIG. 13A is a diagram illustrating a dimensional relation between the machining tool and the workpiece when designing the chamfered tooth flank machining tool;

FIG. 13B is a diagram illustrating a positional relation between the machining tool and the workpiece when designing the chamfered tooth flank machining tool;

FIG. 14A is a diagram illustrating a schematic configuration of a left chamfered tooth flank machining tool viewed in the radial direction;

FIG. 14B is a diagram illustrating a schematic configuration of a right chamfered tooth flank machining tool viewed in the radial direction;

FIG. 15A is a diagram illustrating a positional relation between the machining tool and the workpiece when changing the tool position of the machining tool in the direction of the rotation axis;

FIG. 15B is a first diagram illustrating a machining state at the time when an axial direction position is changed;

FIG. 15C is a second diagram illustrating a machining state at the time when the axial direction position is changed;

FIG. 15D is a third diagram illustrating a machining state at the time when the axial direction position is changed;

FIG. 16A is a diagram illustrating a positional relation between the machining tool and the workpiece when changing an intersection angle representing an inclination of the rotation axis of the machining tool with respect to a rotation axis of the workpiece;

FIG. 16B is a first diagram illustrating a machining state at the time when the intersection angle is changed;

FIG. 16C is a second diagram illustrating a machining state at the time when the intersection angle is changed;

FIG. 16D is a third diagram illustrating a machining state at the time when the intersection angle is changed;

FIG. 17A is a diagram illustrating a positional relation between the machining tool and the workpiece when changing the position of the machining tool in the direction of the rotation axis and the intersection angle;

FIG. 17B is a first diagram illustrating a machining state at the time when the axial direction position and the intersection angle are changed;

FIG. 17C is a second diagram illustrating a machining state at the time when the axial direction position and the intersection angle are changed;

FIG. 18A is a diagram illustrating a burr formation state at the time when the inner tooth flank is roughly/intermediately finished viewed in the radial direction;

FIG. 18B is a diagram illustrating a burr formation state at the time when the chamfered tooth flank is machined viewed in the radial direction;

FIG. 18C is a diagram illustrating a burr formation state at the time when the tapered tooth flank is machined viewed in the radial direction;

FIG. 18D a diagram illustrating a burr removal state at the time when the inner tooth flank is finished viewed in the radial direction;

FIG. 19A is a diagram illustrating a position of the machining tool before machining the left tapered tooth flank viewed in the radial direction;

FIG. 19B is a diagram illustrating a position of the machining tool when machining the left tapered tooth flank viewed in the radial direction;

FIG. 19C is a diagram illustrating a position of the machining tool after machining the left tapered tooth flank viewed in the radial direction;

FIG. 20 is a diagram illustrating torsion angles of the inner tooth flank, the tapered tooth flank, and the chamfered tooth flank, a torsion angle of the machining tool, and an intersection angle when machining the tooth flanks with the machining tool;

FIG. 21 is a diagram illustrating an overall configuration of a machining device according to an embodiment of the invention;

FIG. 22 is a flowchart for describing a tool designing process for a machining tool by a control device illustrated in FIG. 21;

FIG. 23 is a flowchart for describing a machining control process for an inner tooth flank and a chamfered tooth flank by the control device illustrated in FIG. 21;

FIG. 24 is a flowchart following FIG. 23 for describing a machining control process for a tapered tooth flank and the inner tooth flank by the control device illustrated in FIG. 21;

FIG. 25A is a diagram for describing an approach distance and a cutting distance when machining a left tooth flank;

FIG. 25B is a diagram for describing an approach distance and a cutting distance when machining a left tapered tooth flank;

FIG. 25C is a diagram for describing an approach distance and a cutting distance when machining a right chamfered tooth flank;

FIG. 26A is a diagram for describing a correction angle when machining the left tooth flank;

FIG. 26B is a diagram for describing a correction angle when machining the left tapered tooth flank;

FIG. 26C is a diagram for describing a correction angle when machining the right chamfered tooth flank;

FIG. 27A is a diagram illustrating torsion angle of the inner tooth flank, the tapered tooth flank, and the chamfered tooth flank, a torsion angle of the machining tool, and a correction angle when machining the tooth flanks with the machining tool;

FIG. 27B is a diagram illustrating torsion angles of the inner tooth flank, the tapered tooth flank, and the chamfered tooth flank, a torsion angle of the machining tool, and a correction angle when machining the tooth flanks with the machining tool when torsion angles of the tapered tooth flank and the chamfered tooth flank are large, torsion angles of the left and right tapered tooth flanks are the same, and torsion angles of the left and right chamfered tooth flanks are the same;

FIG. 27C is a diagram illustrating torsion angles of the inner tooth flank, the tapered tooth flank, and the chamfered tooth flank, a torsion angle of the machining tool, and a correction angle when machining the tooth flanks with the machining tool when torsion angles of the tapered tooth flank and the chamfered tooth flank are large, torsion angles of the left and right tapered tooth flanks are different, and torsion angles of the left and right chamfered tooth flanks are different;

FIG. 28 is a cross-sectional view illustrating a synchromesh mechanism having the sleeve, which is a workpiece;

FIG. 29A is a cross-sectional view illustrating a state of the synchromesh mechanism illustrated in FIG. 28 before starting operation;

FIG. 29B is a cross-sectional view illustrating a state of the synchromesh mechanism illustrated in FIG. 28 during operation;

FIG. 29C is a cross-sectional view illustrating a state of the synchromesh mechanism illustrated in FIG. 28 after completion of operation;

FIG. 30 is a perspective view illustrating a gear coming-off preventing section of the sleeve, which is a workpiece; and

FIG. 31 is a diagram of the gear coming-off preventing section of the sleeve in FIG. 30 viewed from the radial direction.

### DETAILED DESCRIPTION OF INVENTION

### First Embodiment

### 1-1. Configuration of a Machining Device

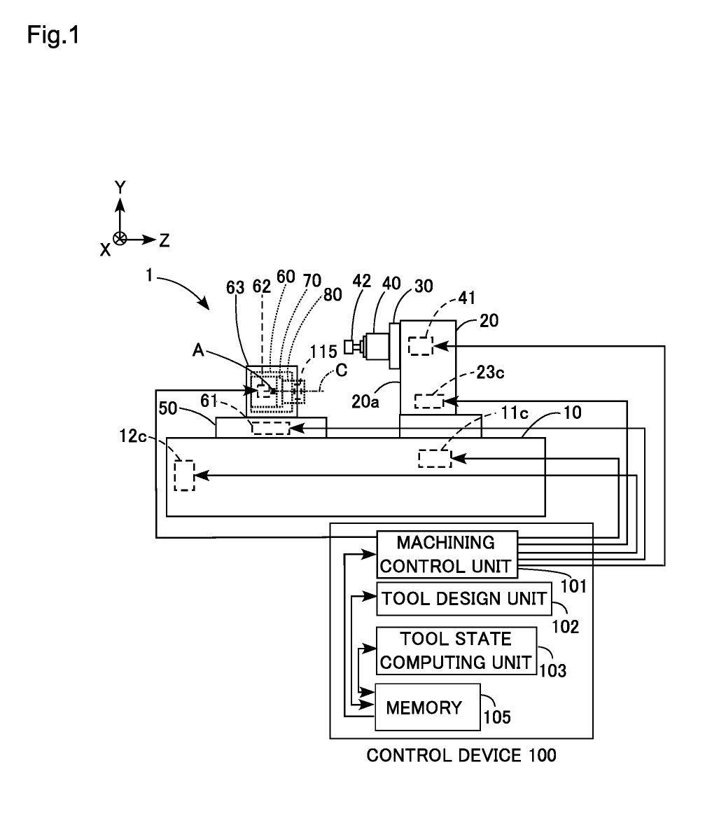

In a first embodiment, a five-axis machining center which is capable of machining a gear is exemplified as a machining device and is described with reference to FIG. 1. In other word, the machining device 1 is a device having drive axes including three rectilinear axes (X, Y, and Z axes) orthogonal to one another and two rotation axes (an A-axis parallel to the X-axis and a C-axis perpendicular to the A-axis).

As described in Background Art, the machining of the gear coming-off preventing section 120 includes various kinds of machining. Therefore, a machining time tends to be long. The gear coming-off preventing section 120 is formed by rolling or punching, which is plastic forming. Therefore, burrs are formed and machining accuracy tends to be low. Therefore, in the machining device 1 described above, a left tooth flank 115b and a right tooth flank 115c of an inner tooth 115a of a sleeve 115, a left chamfered tooth flank 131 and a right chamfered tooth flank 132 of the gear coming-off preventing section 120, and a left tapered tooth flank 121 and a right tapered tooth flank 122 of the gear coming-off preventing section 120 are formed by cutting by a machining tool 42 described below.

That is, the sleeve 115 and the machining tool 42 are rotated synchronously with each other and the machining tool 42 is fed in a direction of a rotation axis of a workpiece W, whereby first, the left tooth flank 115b and the right tooth flank 115c of the inner tooth 115a of the sleeve 115 are roughly cut and intermediately finish-cut and, subsequently, the left chamfered tooth flank 131 and the right chamfered tooth flank 132 of the gear coming-off preventing section 120 are cut. Subsequently, the left tapered tooth flank 121 and the right tapered tooth flank 122 of the gear coming-off preventing section 120 are cut. Finally, the left tooth flank 115b and the right tooth flank 115c of the inner tooth 115a of the sleeve 115 are finish-cut. Consequently, all the tooth flanks can be machined by only the cutting. Further, burrs formed in the cuttings can be removed in order. In particular, burrs formed last can be removed by the finish-cutting. Therefore, it is possible to more greatly reduce a machining time than in the past.

As illustrated in FIG. 1, the machining device 1 is configured by a bed 10, a column 20, a saddle 30, a rotary spindle 40, a table 50, a tilt table 60, a turn table 70, a workpiece holder 80, a control device 100, and the like. Although not illustrated, a publicly-known automatic tool replacement device is provided side by side with the bed 10.

The bed 10 is formed in a substantially rectangular shape and is disposed on a floor. A not-illustrated X-axis ball screw for driving the column 20 in a direction parallel to the X-axis is disposed on an upper surface of the bed 10. In addition, an X-axis motor 11c configured to drive the X-axis ball screw to rotate is disposed on the bed 10.

A not-illustrated Y-axis ball screw for driving the saddle 30 in a direction parallel to the Y-axis is disposed on a side surface (sliding surface) 20a of the column 20 parallel to the Y-axis. A Y-axis motor 23c configured to drive the Y-axis ball screw to rotate is disposed in the column 20.

The rotary spindle 40 supports the machining tool 42, is rotatably supported in the saddle 30, and is rotated by a spindle motor 41 accommodated in the saddle 30. The machining tool 42 is held by a not-illustrated tool holder and fixed to a distal end of the rotary spindle 40 and rotates according to the rotation of the rotary spindle 40. The machining tool 42 moves with respect to the bed 10 in a direction parallel to the X-axis and in a direction parallel to the Y-axis according to the movement of the column 20 and the saddle 30. The machining tool 42 is described in detail below.

A not-illustrated Z-axis ball screw for driving the table 50 in a direction parallel to the Z-axis is disposed on the upper surface of the bed 10. A Z-axis motor 12c configured to drive the Z-axis ball screw to rotate is disposed on the bed 10.

On the upper surface of the table 50, a tilt table support section 63 configured to support the tilt table 60 is provided. In the tilt table support section 63, the tilt table 60 is provided to be rotatable (pivotable) about an axis parallel to the A-axis. The tilt table 60 is rotated (pivoted) by an A-axis motor 61 accommodated in the table 50.

In the tilt table 60, the turn table 70 is provided to be rotatable about an axis parallel to the C-axis. The workpiece holder 80 configured to hold the sleeve 115 as a workpiece is mounted on the turn table 70. The turn table 70 is rotated by a C-axis motor 62 together with the sleeve 115 and the workpiece holder 80.

The control device 100 includes a machining control unit 101, a tool design unit 102, a tool state computing unit 103, a memory 105 and the like. The machining control unit 101, the tool design unit 102, the tool state computing unit 103, and the memory 105 can be respectively configured by separate kinds of hardware or can be respectively implemented by software.

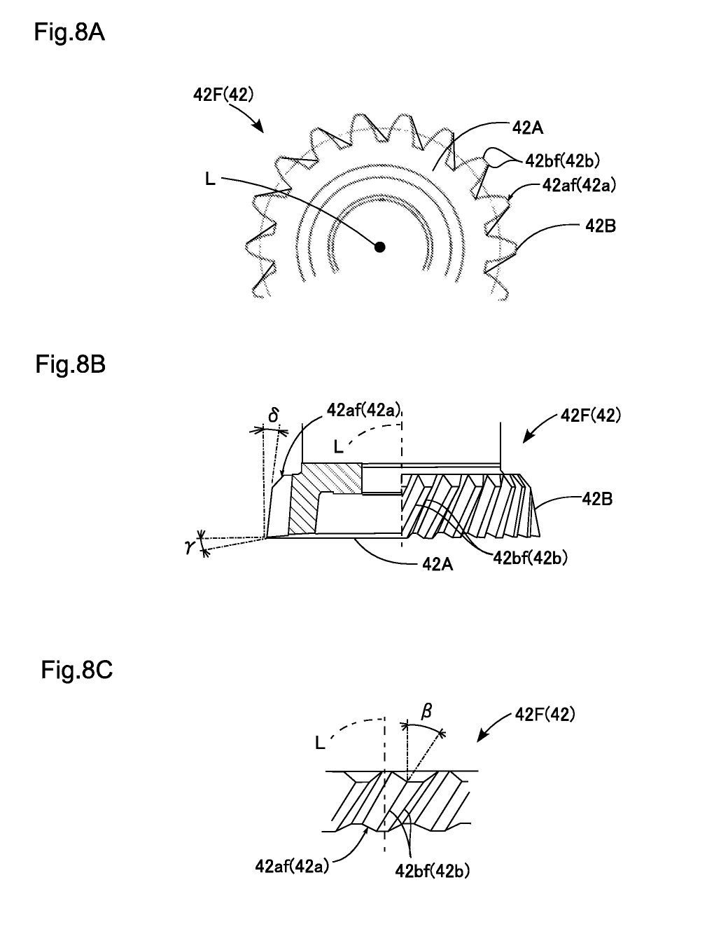

The machining control unit 101 controls the spindle motor 41 to rotate the machining tool 42. The machining control unit 101 controls the X-axis motor 11c, the Z-axis motor 12c, the Y-axis motor 23c, the A-axis motor 61, and the C-axis motor 62 to move the sleeve 115 and the machining tool 42 relative to each other in the direction parallel to the X-axis direction, in the direction parallel to the Z-axis direction, in the direction parallel to the Y-axis direction, about the axis parallel to the A-axis, and about the axis parallel to the C-axis. That is, the machining control unit 101 controls the C-axis motor 62 to set a rotation axis Lw of the sleeve 115 serving as a workpiece and a rotation axis L of the machining tool 42 to a predetermined intersection angle ϕ (see FIG. 8A) and controls the spindle motor 41 and the A-axis motor 61 to synchronously rotate the machining tool 42 and the sleeve 115. In this way, the machining control unit 101 performs cutting of the sleeve 115.

As described below in detail, the tool design unit 102 calculates a torsion angle β (see FIG. 8C) and the like of a cutting blade 42a of the machining tool 42 to design the machining tool 42.

As described below in detail, the tool state computing unit 103 computes a tool state, which is a relative position and a relative posture of the machining tool 42 with respect to the sleeve 115.

In the memory 105, tool data relating to the machining tool 42, that is, a cutting edge circle diameter da, a reference circle diameter d, an addendum ha, a module m, an addendum modification coefficient λ, a pressure angle α, a front pressure angle αt, and a cutting edge pressure angle αa as well as machining data for cutting the sleeve 115 are stored in advance. The memory 105 stores, for example, a number of blades Z of the cutting blade 42a input when designing the machining tool 42. The memory 105 stores shape data of the machining tool 42 designed by the tool design unit 102 and a tool state computed by the tool state computing unit 103.

### 1-2. Machining Tool

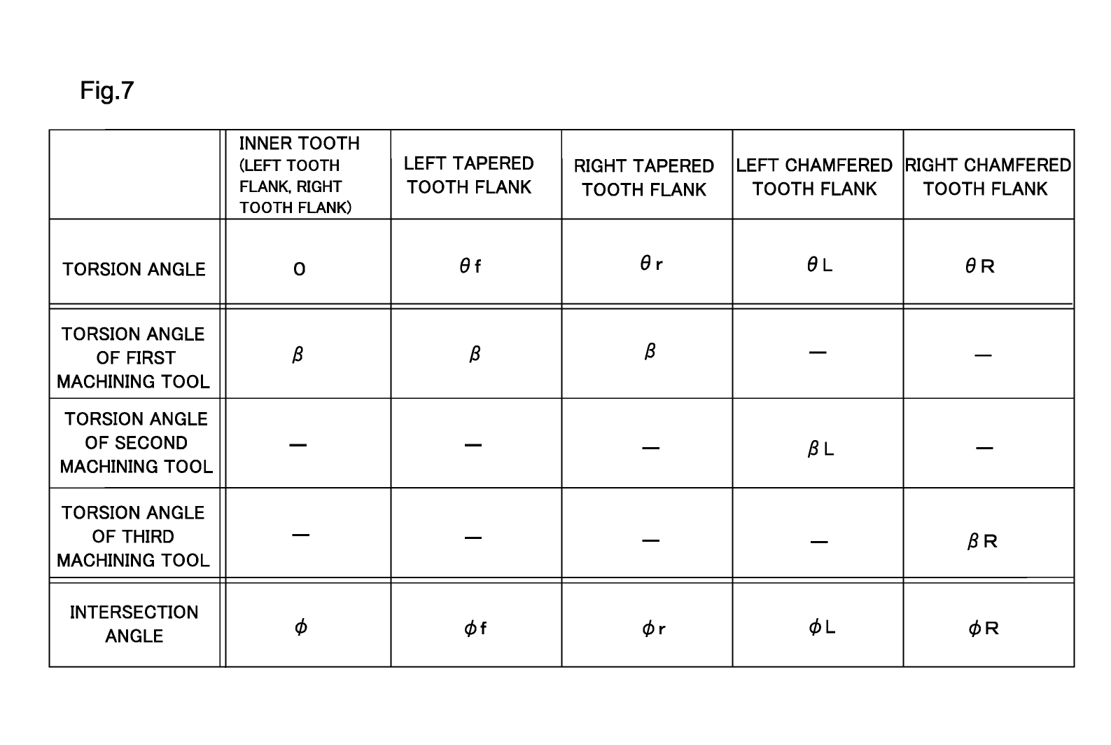

The inventor found that it is possible to cope with cutting of the gear coming-off preventing section 120 of the sleeve 115 by respectively changing intersection angles represented by differences between torsion angles of tooth flanks of gears and torsion angles of cutting blades in three machining tools 42. As the three machining tools 42, specifically, as illustrated in FIG. 7, a machining tool (hereinafter referred to as first machining tool 42F) for cutting the left tooth flank 115b and the right tooth flank 115c of the inner tooth 115a of the sleeve 115, the left tapered tooth flank 121 including the left sub-tooth flank 121a, and the right tapered tooth flank 122 including the right sub-tooth flank 122a is used. Further, a machining tool (hereinafter referred to as second machining tool 42L) for cutting the left chamfered tooth flank 131 is used. Further, a machining tool (hereinafter referred to as third machining tool 42R) for cutting the right chamfered tooth flank 132 is used.

Torsion angles of the left tooth flank 115b and the right tooth flank 115c of the inner tooth 115a, the left tapered tooth flank 121, the right tapered tooth flank 122, the left chamfered tooth flank 131, and the right chamfered tooth flank 132 of the gear coming-off preventing section 120 of the sleeve 115 in this example are θ degree, θf degrees, θr degrees, θL degrees, and θR degrees. Torsion angles of the first machining tool 42F, the second machining tool 42L, and the third machining tool 42R are β degrees, βL degrees, and βR degrees.

An intersection angle (a first intersection angle) in cutting the left tooth flank 115b and the right tooth flank 115c of the inner tooth 115a with the first machining tool 42F is ϕ. An intersection angle (a fourth intersection angle) in cutting the left tapered tooth flank 121 with the first machining tool 42F is ϕf. An intersection angle (a fifth intersection angle) in cutting the right tapered tooth flank 122 with the first machining tool 42F is ϕr. An intersection angle (a second intersection angle) in cutting the left chamfered tooth flank 131 with the second machining tool 42L is ϕL. An intersection angle (a third intersection angle) in cutting the right chamfered tooth flank 132 with the first machining tool 42F is ϕR.

In this way, the torsion angles of the cutting blades of the three machining tools 42 can be determined based on the torsion angles of the tooth flanks of the gear and the intersection angles set in the machining device 1. Therefore, the three machining tools 42 can be easily designed. The gear coming-off preventing section 120 is formed by the cutting. Therefore, it is possible to improve machining accuracy and surely prevent gear coming-off.

First, designing of the first machining tool 42F is described. The first machining tool 42F is designed based on the shapes of the left tooth flank 115b and the right tooth flank 115c of the inner tooth 115a, the left tapered tooth flank 121, and the right tapered tooth flank 122. As illustrated in FIG. 8A, the shape of a cutting blade 42af at the time when the first machining tool 42F is viewed from the tool end surface 42A side in the direction of the tool axis (rotation axis) L is formed in the same shape as the involute curve in this example.

As illustrated in FIG. 8B, the cutting blade 42af of the first machining tool 42F has a rake angle inclined by an angle γ with respect to a plane perpendicular to the tool axis L on the tool end surface 42A side and a front clearance angle inclined by an angle δ with respect to a straight line parallel to the tool axis L on a tool peripheral surface 42B side. As illustrated in FIG. 8C, blade traces 42bf of the cutting blade 42af have a torsion angle inclined by an angle β with respect to a straight line parallel to the tool axis L.

As described above, in the cutting of the gear coming-off preventing section 120 of the sleeve 115, first, the left tooth flank 115b and the right tooth flank 115c of the inner tooth 115a are formed and, subsequently, the left tapered tooth flank 121 and the right tapered tooth flank 122 are formed with respect to the already formed inner tooth 115a. In this example, the torsion angles of the left tooth flank 115b and the right tooth flank 115c of the inner tooth 115a are 0 degree. Therefore, the cutting blade 42af of the first machining tool 42F does not interfere with the inner tooth 115a adjacent to the cutting edge 42af during the cutting of the inner tooth 115a.

On the other hand, the left tapered tooth flank 121 including the left sub-tooth flank 121a and the right tapered tooth flank 122 including the right sub-tooth flank 122a have torsion angles. Therefore, the cutting blade 42af of the first machining tool 42F needs to have a shape for enabling the left tapered tooth flank 121 including the left sub-tooth flank 121a and the right tapered tooth flank 122 including the right sub-tooth flank 122a to be surely cut without interfering with the adjacent inner tooth 115a during cutting of the inner tooth 115a. In the following description, the left tapered tooth flank 121 including the left sub-tooth flank 121a is described as an example. The same applies to the right tapered tooth flank 122 including the right sub-tooth flank 122a.

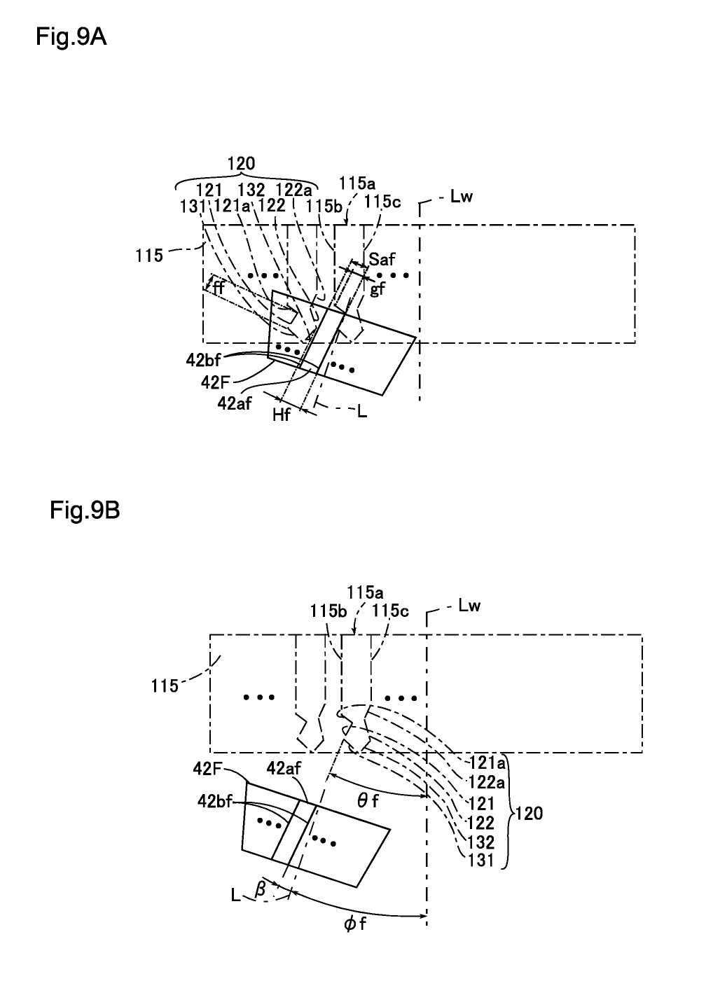

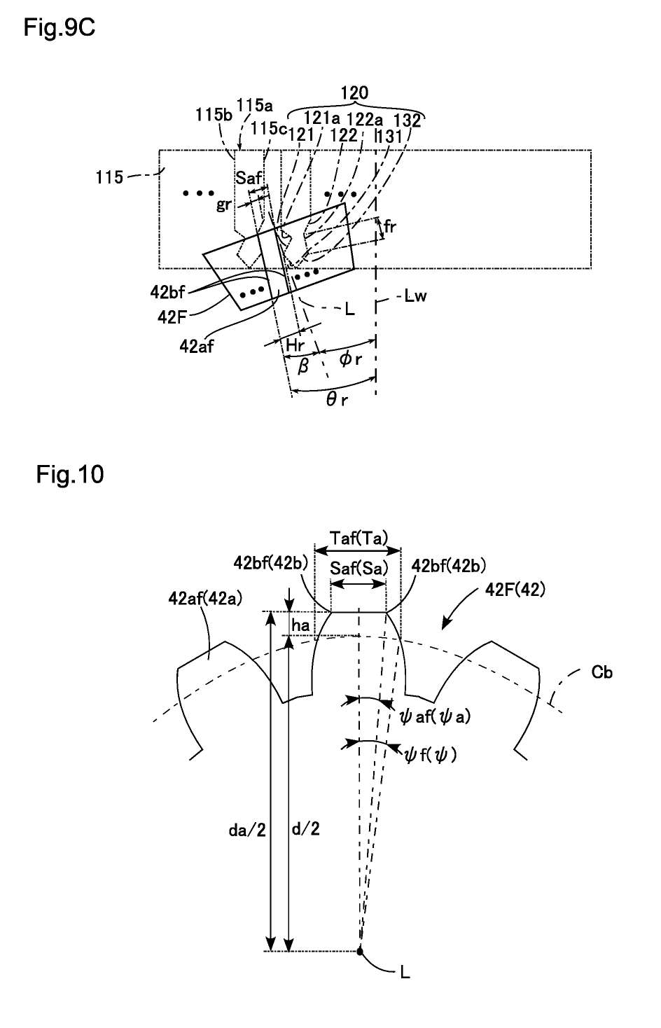

Specifically, as illustrated in FIG. 9A, the cutting blade 42af is designed such that a cutting edge width Saf of the cutting edge 42a is larger than a tooth trace length gf of the left sub-tooth flank 121a when the cutting blade 42af cuts the left tapered tooth flank 121 by a tooth trace length ff. Further, the cutting blade 42af needs to be designed such that a blade thickness Taf (see FIG. 10) on a reference circle Cb of the cutting blade 42af is equal to or smaller than a distance Hf (hereinafter referred to as tooth flank interval Hf) between the left tapered tooth flank 121 and an opened end of the right tapered tooth flank 122 facing the left tapered tooth flank 121. At this time, the cutting edge width Saf of the cutting blade 42af and the blade thickness Taf on the reference circle Cb of the cutting blade 42af are set considering durability of the cutting blade 42af, for example, a defect of the cutting blade 42af.

In designing the cutting blade 42af, as illustrated in FIG. 9B, first, an intersection angle ϕf (hereinafter referred to as intersection angle ϕf of the first machining tool 42F) represented by a difference between a torsion angle θf of the left tapered tooth flank 121 and a torsion angle β of the cutting blade 42af needs be set. The torsion angle θf of the left tapered tooth flank 121 is a known value. A possible range of setting of an intersection angle ϕf of the first machining tool 42F is set by the machining device 1. Therefore, an operator provisionally sets any intersection angle ϕf.

Subsequently, the torsion angle β of the cutting blade 42af is calculated from the known torsion angle θf of the left tapered tooth flank 121 and the set intersection angle ϕf of the first machining tool 42F. The cutting edge width Saf of the cutting blade 42af and the blade thickness Taf on a reference circle Cb of the cutting blade 42af are calculated. By repeating the process described above, the first machining tool 42F including the optimal cutting blade 42af for cutting the left tapered tooth flank 121 is designed. An example of computation for calculating the cutting edge width Saf of the cutting blade 42af and the blade thickness Taf on the reference circle Cb of the cutting blade 42af is described below.

As illustrated in FIG. 10, the cutting edge width Saf of the cutting blade 42af is represented by a cutting edge circle diameter da and a half angle ψaf of the blade thickness of the cutting edge circle (see Expression (1)).

Expression 1

Saf=ψaf·da (1)

The cutting edge circle diameter da is represented by the reference circle diameter d and the addendum ha (see Expression (2)). Further, the reference circle diameter d is represented by the number of blades Z of the cutting blade 42af, the torsion angle β of the blade traces 42bf of the cutting blade 42af, and a module m (see Expression (3)). The addendum ha is represented by an addendum modification coefficient λ and the module m (see Expression (4)).

Expression 2

da=d+2·ha (2)

Expression 3

d=Z·m/cos β (3)

Expression 4

ha=2·m(1+λ) (4)

The half angle ψaf of the blade thickness of the cutting edge circle is represented by the number of blades Z of the cutting blade 42af, the addendum modification coefficient λ, the pressure angle α, a front pressure angle αt, and a cutting edge pressure angle αa (see Expression (5)). The front pressure angle αt can be represented by the pressure angle α and the torsion angle β of the blade traces 42bf of the cutting blade 42af (see Expression (6)). The cutting edge pressure angle αa is represented by the front pressure angle αt, the cutting edge circle diameter da, and the reference circle diameter d (see Expression (7)).

Expression 5

ψaf=π/(2·Z)+2·λ·tan α/Z+(tan αt−αt)−(tan αa−αa) (5)

Expression 6

αt=tan⁻¹(tan α/cos β) (6)

Expression 7

αa=cos⁻¹(d·cos αt/da) (7)

The blade thickness Taf of the cutting blade 42af is represented by the reference circle diameter d and the half angle ψf of the blade thickness Taf (see Expression (8)).

Expression 8

Taf=ψf·d (8)

The reference circle diameter d is represented by the number of blades Z of the cutting blade 42af, the torsion angle β the blade traces 42bf of the cutting blade 42af, and the module m (see Expression (9)).

Expression 9

d=Z·m/cos β (9)

The half angle ψf of the blade thickness Taf is represented by the number of blades Z of the cutting blade 42af, the addendum modification coefficient λ, and the pressure angle α (see Expression (10)).

Expression 10

ψf=π/(2·Z)+2·λ·tan α/Z (10)

The process for the left tapered tooth flank 121 described above is performed for the right tapered tooth flank 122 in the same manner as illustrated in FIG. 9C. In FIG. 9C, a tooth trace length of the right tapered tooth flank 122 is indicated by fr, a tooth trace length of the right sub-tooth flank 122a is indicated by gr, and the distance between the right tapered tooth flank 122 and the open end of the left tapered tooth flank 121 facing the right tapered tooth flank 122 is indicated by Hr (hereinafter referred to as tooth flank interval Hr).

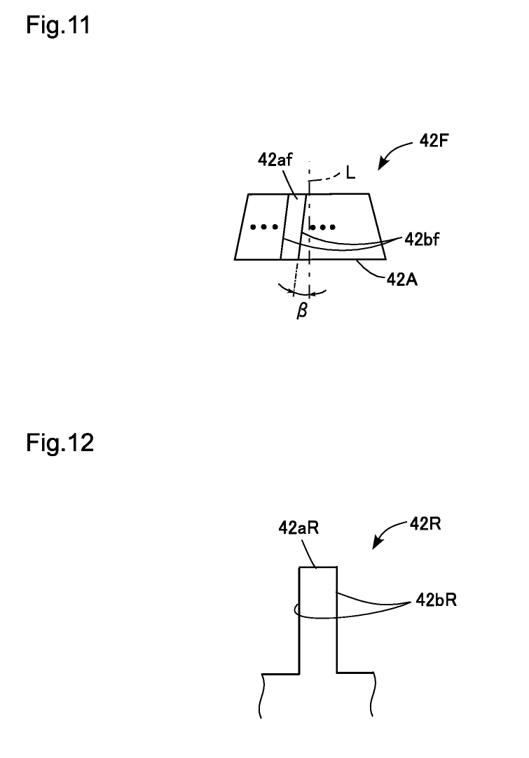

Consequently, as illustrated in FIG. 11, the first machining tool 42F is designed such that the blade traces 42bf of the cutting blade 42af have the torsion angle α inclined from lower left to upper right when the tool end surface 42A is viewed downward in the figure from a direction perpendicular to the tool axis L. The designing of the first machining tool 42F described above is performed in the tool design unit 102 of the control device 100. Details of a process of the design are described below.

Designing of the third machining tool 42R is described. The third machining tool 42R is designed based on the shape of the right chamfered tooth flank 132. Like the third machining tool 42R, the second machining tool 42L is designed based on the shape of the left chamfered tooth flank 131. Detailed description concerning the design is omitted.

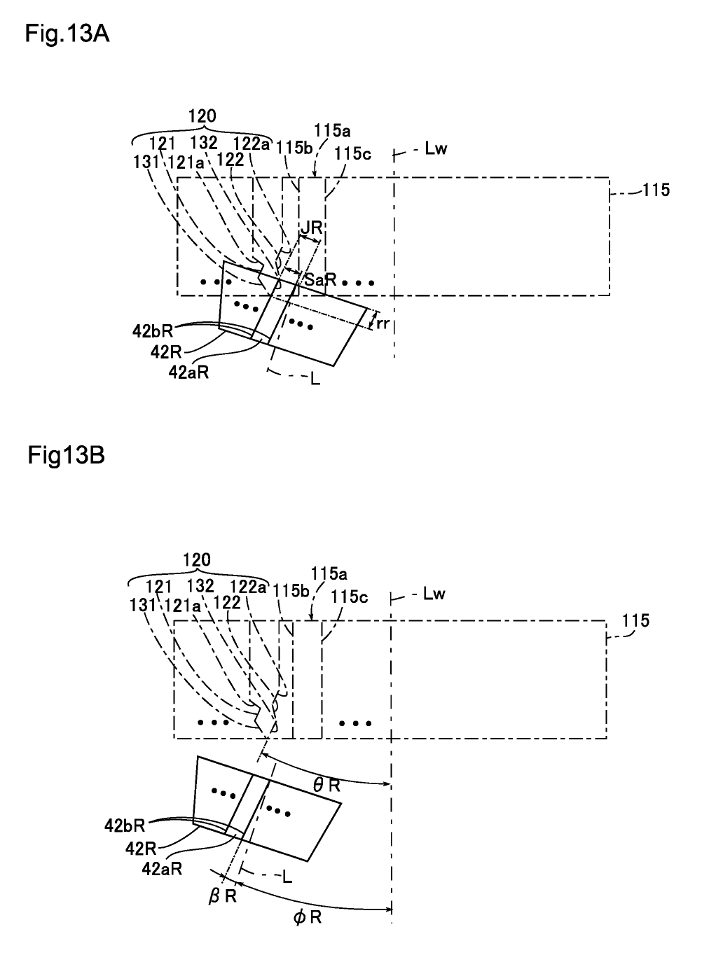

Compared with the shape of the first machining tool 42F described above (see FIGS. 8A, 8B, and 8C), the third machining tool 42R is formed into substantially the same shape except the shape of the cutting blade 42af of the first machining tool 42F (the shape of the involute curve). That is, as illustrated in FIG. 12, the shape of a cutting blade 42aR of the third machining tool 42R is formed into substantially rectangular shape in this example because a pressure angle of the right chamfered tooth flank 132 is substantially 0 degree.

The right chamfered tooth flank 132 of the sleeve 115 is formed by cutting the inner tooth 115a of the already formed sleeve 115 with the third machining tool 42R. Therefore, the cutting blade 42aR of the third machining tool 42R needs to be formed into a shape for enabling the right chamfered tooth flank 132 to be surely cut without interfering with the adjacent inner tooth 115a during the cutting of the inner tooth 115a.

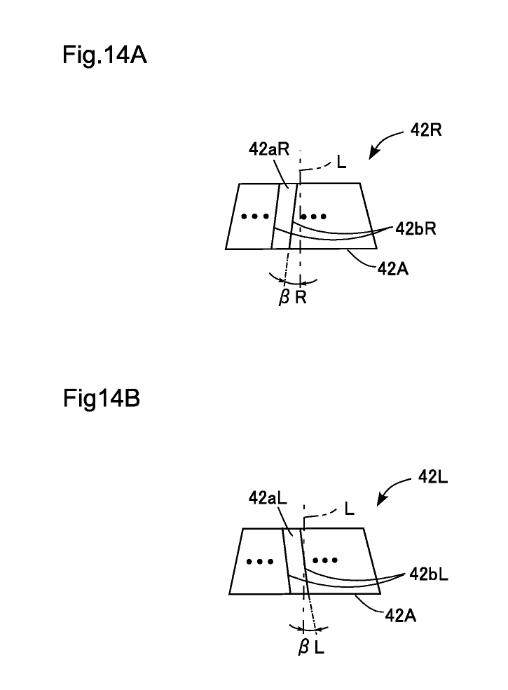

Specifically, as illustrated in FIG. 13A, the cutting blade 42aR needs to be designed such that a cutting edge width SaR of the cutting blade 42aR is equal to or smaller than a distance JR between the right chamfered tooth flank 132 and the left tooth flank 115b of the inner tooth 115a facing the right chamfered tooth flank 132 (hereinafter referred to as tooth flank interval JR) when the cutting blade 42aR cuts the right chamfered tooth flank 132 by a tooth trace length rr. At this time, the cutting edge width SaR of the cutting blade 42aR is set considering durability of the cutting blade 42aR, for example, a defect of the cutting blade 42aR.

In designing the cutting blade 42aR, as illustrated in FIG. 13B, an intersection angle ϕR represented by a difference between a torsion angle θR of the right chamfered tooth flank 132 and a torsion angle βR of the cutting blade 42aR (hereinafter referred to as intersection angle ϕR of the third machining tool 42R) needs to be set. The torsion angle θR of the right chamfered tooth flank 132 is a known value. A possible range of setting of the intersection angle ϕR of the third machining tool 42R is set by the machining device 1. Therefore, an operator provisionally sets any intersection angle ϕR.

Subsequently, the torsion angle βR of the cutting blade 42aR is calculated from the known torsion angle θR of the right chamfered tooth flank 132 and the set intersection angle ϕR of the third machining tool 42R and the cutting edge width SaR of the cutting blade 42aR is calculated. By repeating the process described above, the third machining tool 42R including the optimal cutting blade 42aR for cutting the right chamfered tooth flank 132 is designed.

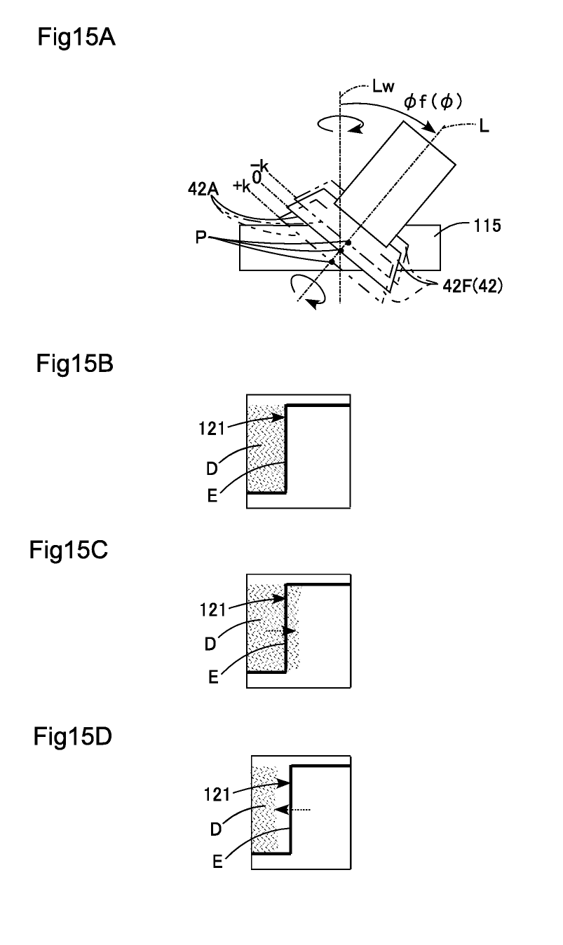

Consequently, as illustrated in FIG. 14A, the third machining tool 42R is designed such that the blade traces 42bR of the cutting blade 42aR have the torsion angle βR inclined from lower left to upper right when the tool end surface 42A is viewed downward in the figure from a direction perpendicular to the tool axis L. As illustrated in FIG. 14B, the second machining tool 42L is designed such that the blade traces 42bL of the cutting blade 42aL have a torsion angle βL inclined from lower right to upper left when the tool end surface 42A is viewed downward in the figure from a direction perpendicular to the tool axis L.

### 1-3. Tool State of the Machining Tool in the Machining Device

Machining accuracy achieved when the designed first machining tool 42F is applied to the machining device 1 and the left tapered tooth flank 121 is cut by changing a tool state of the first machining tool 42F such as a position of the tool in the direction of the tool axis L of the first machining tool 42F (hereinafter referred to as axial direction position of the first machining tool 42F) and the intersection angle ϕf of the first machining tool 42F is examined below.

The same applies to machining accuracy achieved when the left tooth flank 115b, the right tooth flank 115c, and the right tapered tooth flank 122 of the inner tooth 115a are cut by the first machining tool 42F. Therefore, detailed description is omitted. The same applies to machining accuracy achieved when the left chamfered tooth flank 131 is cut by the second machining tool 42L. Therefore, detailed description is omitted. The same applies to machining accuracy achieved when the right chamfered tooth flank 132 is cut by the third machining tool 42R. Therefore, detailed description is omitted.

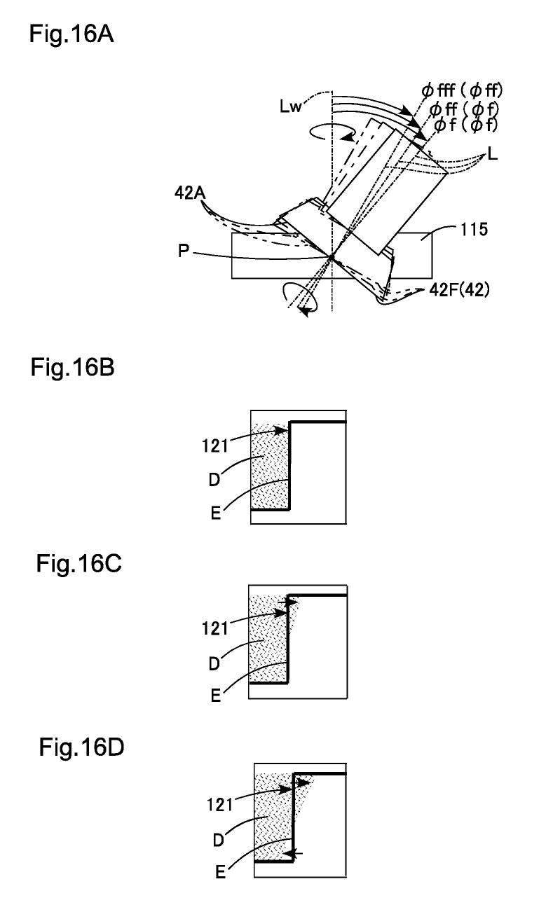

For example, as illustrated in FIG. 15A, the left tapered tooth flank 121 was machined in a state in which the axial direction position of the first machining tool 42F, that is, an intersection point P between the tool end surface 42A and the tool axis L of the first machining tool 42F was located on a rotation axis Lw of the sleeve 115 (offset amount: 0). The left tapered tooth flank 121 was machined in a state in which the intersection point P was offset by a distance +k in the direction of the tool axis L of the first machining tool 42F (offset amount: +k). The left tapered tooth flank 121 was machined in a state in which the intersection point P was offset by a distance −k in the direction of the tool axis L of the first machining tool 42F (the offset amount: −k). The intersection angle ϕf of the first machining tool 42F was fixed in all the states.

As a result, machining states of the left tapered tooth flank 121 were as illustrated in FIGS. 15B, 15C, and 15D. Thick solid lines E in the figures indicate involute curves of the left tapered tooth flank 121 in design converted into straight lines and dot portions D indicate cut and removed portions.

As illustrated in FIG. 15B, with an offset amount of 0, the machined left tapered tooth flank 121 is machined into a shape similar to the involute curve in design. On the other hand, as illustrated in FIG. 15C, with the offset amount +k, the machined left tapered tooth flank 121 is machined into a shape shifted rightward (in the direction of a dotted arrow) in the figure, that is, shifted in a direction of a clockwise pitch circle with respect to the involute curve in design. As illustrated in FIG. 15D, with the offset amount −k, the machined left tapered tooth flank 121 is machined into a shape shifted leftward (in the direction of a dotted arrow) in the figure, that is, shifted in a direction of a counterclockwise pitch circle with respect to the involute curve in design. Therefore, the shape of the left tapered tooth flank 121 can be shifted in the pitch circle direction by changing the position in the tool axis line L direction of the machining tool 42.

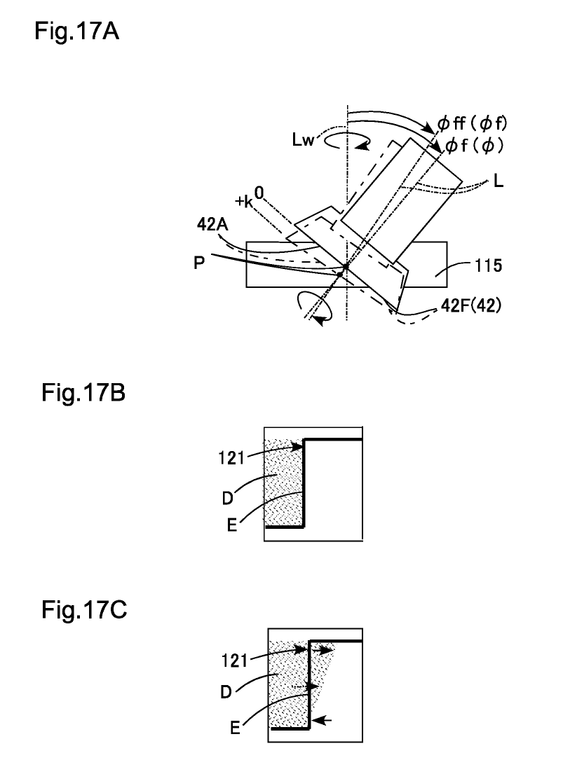

For example, as illustrated in FIG. 16A, the left tapered tooth flank 121 was machined in cases where the intersection angle of the first machining tool 42F was ϕf, ϕff, and ϕfff. A magnitude relation of the angles is ϕf>ϕff>ϕfff. As a result, machining states of the left tapered tooth flank 121 were as illustrated in FIGS. 16B, 16C, and 16D.

As illustrated in FIG. 16B, with the intersection angle ϕf, the machined left tapered tooth flank 121 is machined into a shape similar to the involute curve in design. On the other hand, as illustrated in FIG. 16C, with the intersection angle ϕff, the machined left tapered tooth flank 121 is machined into a shape narrowed in width of the tooth tip in a direction of the pitch circle (in the direction of a solid arrow) and widened in width of the tooth root in the direction of the pitch circle (in the direction of the solid arrow) with respect to the involute curve in design. As illustrated in FIG. 16D, with the intersection angle ϕfff, the machined left tapered tooth flank 121 is machined into a shape further narrowed in width of the tooth tip in a direction of the pitch circle (in the direction of the solid arrow) and further widened in width of the tooth root in the direction of the pitch circle (in the direction of the solid arrow) with respect to the involute curve in design. Therefore, the shape of the left tapered tooth flank 121 can be changed in width of the tooth tip in the direction of the pitch circle and in width of the tooth root in the direction of the pitch circle by changing the intersection angle of the first machining tool 42F.

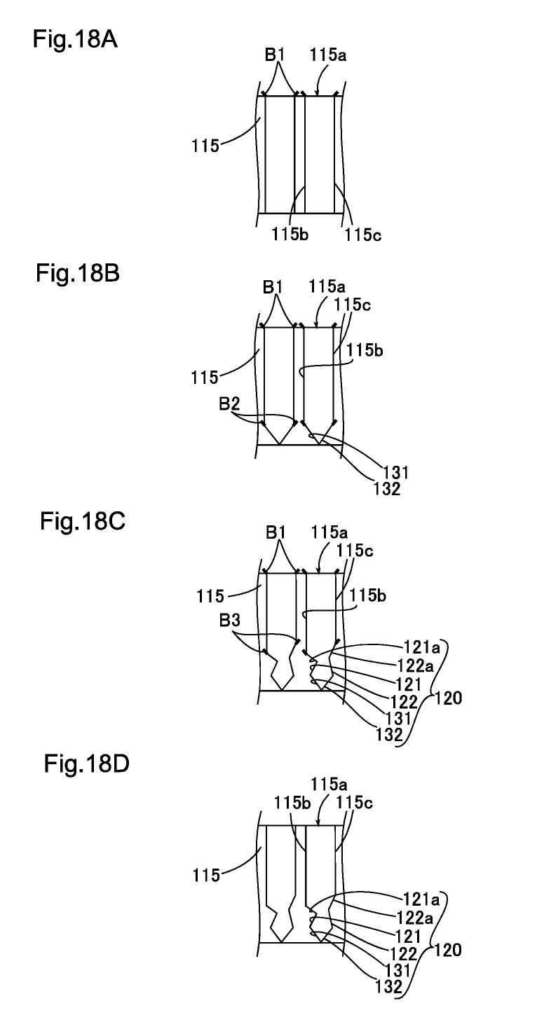

For example, as illustrated in FIG. 17A, the left tapered tooth flank 121 was machined in a state in which the axial direction position of the first machining tool 42F, that is, the intersection point P between the tool end surface 42A and the tool axis L of the first machining tool 42F was located on the rotation axis Lw of the sleeve 115 (offset amount: 0) and the intersection angle of the first machining tool 42F was ϕf. The left tapered tooth flank 121 was machined in a state in which the intersection point P was offset by a distance +k in the direction of the tool axis L of the first machining tool 42F (offset amount: +k) and the intersection angle was ϕff. As a result, machining states of the left tapered tooth flank 121 were as illustrated in FIGS. 17B and 17C.

As illustrated in FIG. 17B, with the offset amount 0 and the intersection angle ϕf, the machined left tapered tooth flank 121 is machined into a shape similar to the involute curve in design. On the other hand, as illustrated in FIG. 17C, with the offset amount +k and the intersection angle ϕff, the machined left tapered tooth flank 121 is shifted rightward in the figure (in the direction of a dotted arrow), that is, shifted in the clockwise direction of the pitch circle, and is machined into a shape with a tooth tip narrowed in width in the direction of the pitch circle (direction of a solid arrow) and a tooth root widened in the direction of the pitch circle (in the direction of the solid arrow) with respect to the involute curve in design. Therefore, the shape of the left tapered tooth flank 121 can be shifted in the direction of the pitch circle by changing the axial direction position of the machining tool 42 and the intersection angle of the first machining tool 42F. The width of the tooth tip in the circumferential direction and the width of the tooth root in the direction of the pitch circle can be changed.

Consequently, the first machining tool 42F can highly accurately cut the left tapered tooth flank 121 by being set with the offset amount of 0 and the intersection angle ϕf in the machining device 1. The tool states of the first machining tool 42F are set by the tool state computing unit 103 of the control device 100. Details of the process are described below.

### 1-4. Process by the Tool Design Unit of the Control Device

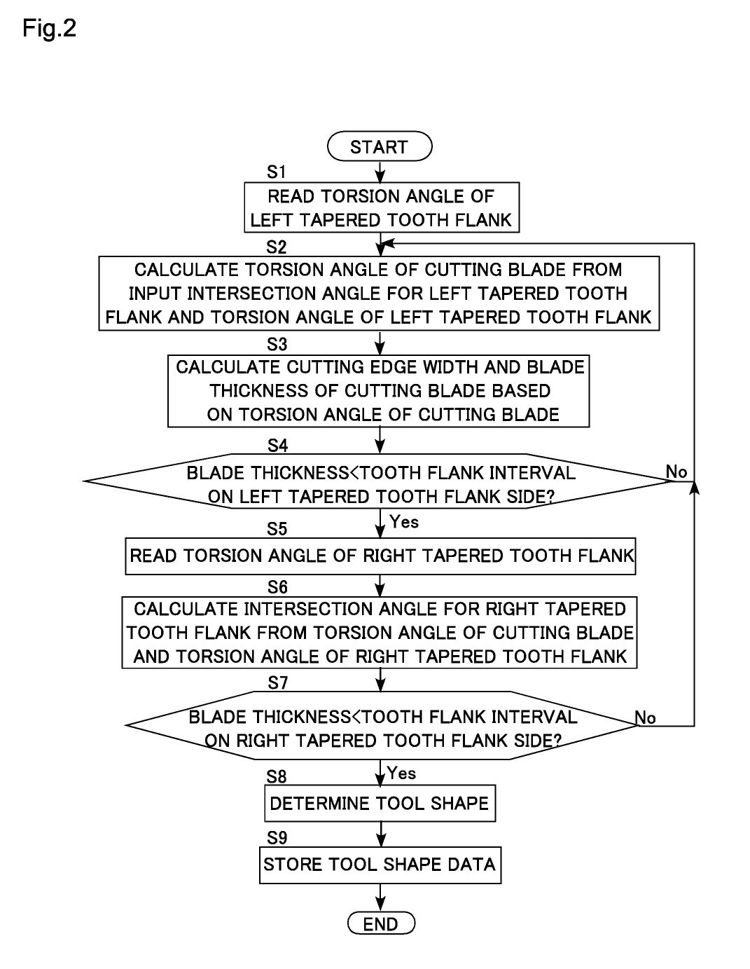

A designing process for the first machining tool 42F by the tool design unit 102 of the control device 100 is described with reference to FIGS. 2, 9A, 9B, and 9C. Data relating to the gear coming-off preventing section 120, that is, the torsion angle θf and the tooth trace length ff of the left tapered tooth flank 121, the tooth trace length gf and the tooth flank interval Hf of the left sub-tooth flank 121a, the torsion angle θr and the tooth trace length fr of the right tapered tooth flank 122, and the tooth trace length gr and the tooth flank interval Hr of the right sub-tooth flank 122a are assumed to be stored in the memory 105 in advance. Further, data relating to the first machining tool 42F, that is, the number of blades Z, the cutting edge circle diameter da, the reference circle diameter d, the addendum ha, the module m, the addendum modification coefficient λ, the pressure angle α, the front pressure angle αt, and the cutting edge pressure angle αa are assumed to be stored in the memory 105 in advance.

The tool design unit 102 of the control device 100 reads the torsion angle θf of the left tapered tooth flank 121 from the memory 105 (step S1 in FIG. 2). Then, the tool design unit 102 calculates a difference between the intersection angle ϕf of the first machining tool 42F in cutting the left tapered tooth flank 121 input by the operator and the read torsion angle θf of the left tapered tooth flank 121 as the torsion angle β of the blade traces 42bf of the cutting blade 42af of the first machining tool 42F (step S2 in FIG. 2).

The tool design unit 102 reads the number of blades Z or the like of the first machining tool 42F from the memory 105 and calculates, based on the read number of blades Z or the like of the first machining tool 42F and the calculated torsion angle β of the blade traces 42bf of the cutting blade 42af, the cutting edge width Saf and the blade thickness Taf of the cutting blade 42af. The cutting edge width Saf of the cutting blade 42af is calculated according to the involute curve based on the blade thickness Taf. If a satisfactory meshing can be maintained in the tooth portion, the tool design unit 102 calculates the cutting edge width Saf as a non-involute or linear tooth flank (step S3 in FIG. 2).

When the calculated blade width Saf of the cutting blade 42af is equal to or smaller than the tooth trace length gf of the left sub-tooth flank 121a, the tool design unit 102 returns to step S2 and repeats the process described above. On the other hand, when the calculated blade width Saf of the cutting blade 42af is larger than the tooth trace length gf of the left sub-tooth flank 121a, the tool design unit 102 reads out the tooth flank interval Hf from the memory 105. The tool design unit 102 determines whether the calculated blade thickness Taf of the cutting blade 42af is smaller than the tooth flank interval Hf on the left tapered tooth flank 121 side (step S4 in FIG. 2).

When the calculated blade thickness Taf of the cutting blade 42af is equal to or larger than the tooth flank interval Hf on the left tapered tooth flank 121 side, the tool design unit 102 returns to step S2 and repeats the process described above. On the other hand, when the calculated blade thickness Taf of the cutting blade 42af is smaller than the tooth flank interval Hf on the left tapered tooth flank 121 side, the tool design unit 102 reads the torsion angle θr of the right tapered tooth flank 122 from the memory 105 (step S5 in FIG. 2). The tool design unit 102 calculates a difference between the torsion angle β of the blade traces 42bf of the cutting blade 42af of the first machining tool 42F calculated in step S2 and the read torsion angle θr of right tapered tooth flank 122 as an intersection angle ϕr (see FIG. 9C) of the first machining tool 42F in cutting the right tapered tooth flank 122 (step S6 in FIG. 2).

The tool design unit 102 reads out the tooth flank interval Hr from the memory 105 and determines whether the blade thickness Taf is smaller than the tooth flank interval Hr on the right tapered tooth flank 122 side (step S7 in FIG. 2). When the blade thickness Taf is equal to or larger than the tooth flank interval Hr on the right tapered tooth flank 122 side, the tool design unit 102 returns to step S2 and repeats the process described above.

On the other hand, when the blade thickness Taf is smaller than the tooth flank interval Hr on the right tapered tooth flank 122 side, the tool design unit 102 determines, based on, for example, the calculated torsion angle β of the blade traces 42bf of the cutting blade 42af, a shape of the first machining tool 42F (step S8 in FIG. 2). The tool design unit 102 stores determined shape data of the first machining tool 42F in the memory 105 (step S9 in FIG. 2) and ends the entire process. Consequently, the first machining tool 42F including the optimal cutting blade 42af is designed.

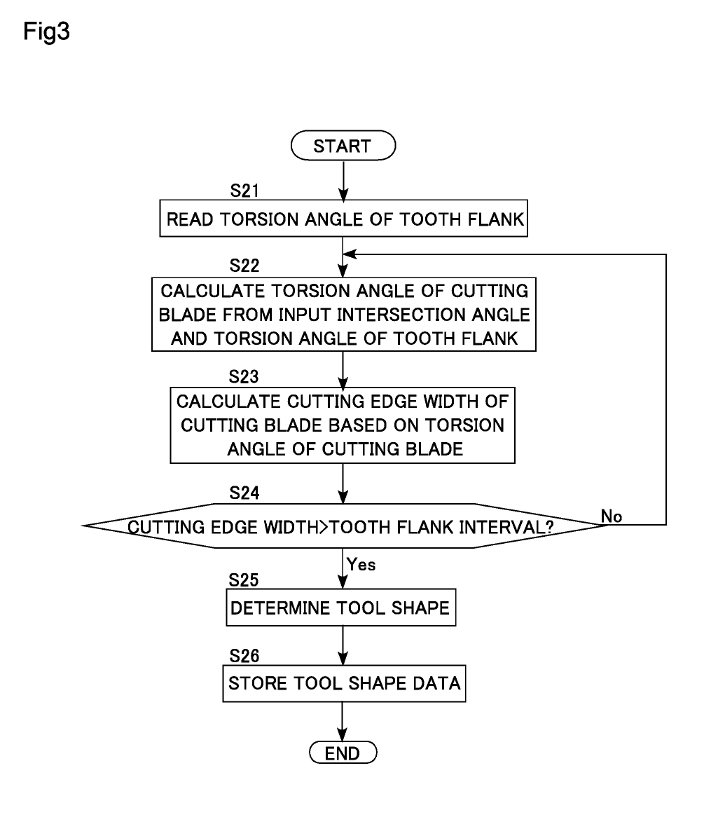

A process for designing the third machining tool 42R by the tool design unit 102 of the control device 100 is described with reference to FIGS. 3, 13A, and 13B. A process for designing the second machining tool 42L is the same. The torsion angle θR, the tooth trace length rr, the height, the pressure angle, and the tooth flank interval JR of the right chamfered tooth flank 132 are assumed to be stored in the memory 105 in advance. Further, data relating to the third machining tool 42R, that is, the number of blades Z, the cutting edge circle diameter da, the reference circle diameter d, the addendum ha, the module m, the addendum modification coefficient λ, the pressure angle α, the front pressure angle βt, and the cutting edge pressure angle αa are assumed to be stored in the memory 105 in advance.

The tool design unit 102 of the control device 100 reads the torsion angle θR of the right chamfered tooth flank 132 from the memory 105 (step S21 in FIG. 3). Then, the tool design unit 102 calculates a difference between the intersection angle ϕR of the third machining tool 42R input by the operator and the read torsion angle θR of the right chamfered tooth flank 132 as a torsion angle βR of the blade traces 42bR of the cutting blade 42aR of the third machining tool 42R (step S22 in FIG. 3).

The tool design unit 102 reads the number of blades Z or the like of the third machining tool 42R from the memory 105 and calculates, based on the read number of blades Z or the like of the third machining tool 42R and the calculated torsion angle βR of the blade traces 42bR of the cutting blade 42aR, the cutting edge width SaR of the cutting blade 42aR (step 23 in FIG. 3). The tool design unit 102 reads out the tooth flank interval JR from the memory 105 and determines whether the calculated cutting edge width SaR of the cutting blade 42aR is smaller than the tooth flank interval JR (step S24 in FIG. 3).

When the calculated blade thickness SaR (the cutting edge width) of the cutting blade 42aR is equal to or larger than the tooth flank interval JR, the tool design unit 102 returns back to step S22 and repeats the process described above. On the other hand, when the calculated blade thickness SaR of the cutting blade 42aR is smaller than the tooth flank interval JR, the tool design unit 102 determines, based on, for example, the calculated torsion angle βR of the blade traces 42bR of the cutting blade 42aR, a shape of the third machining tool 42R (step S25 in FIG. 3). The tool design unit 102 stores determined shape data of the third machining tool 42R in the memory 105 (step S26 in FIG. 3) and ends the entire process. Consequently, the third machining tool 42R including the optimum cutting blade 42aR is designed.

### 1-5. Process by the Tool State Computing Unit of the Control Device

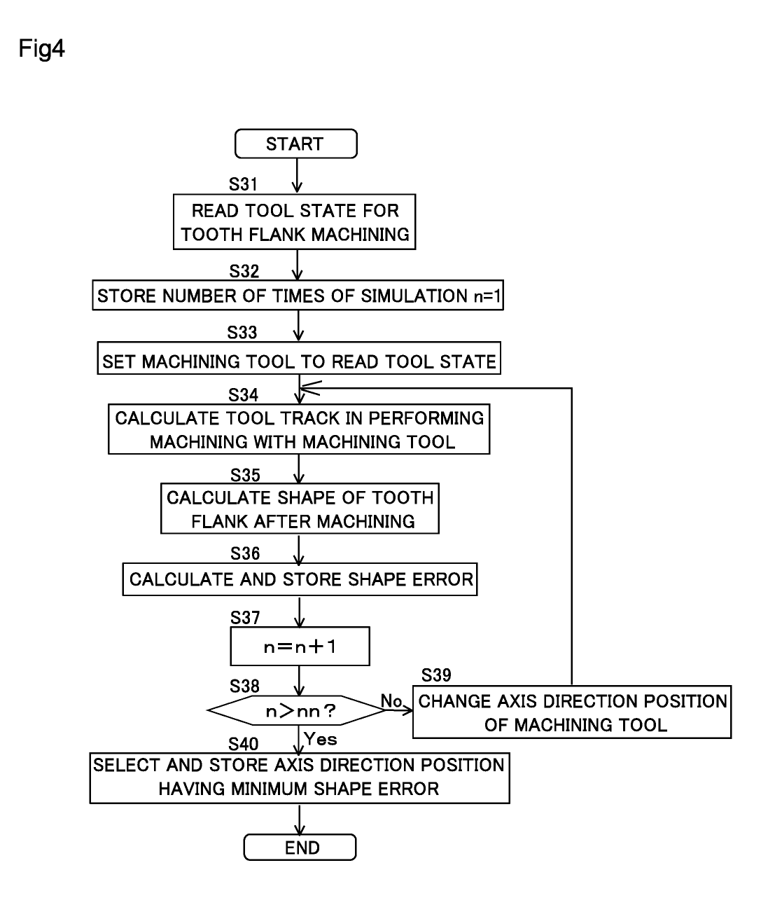

A process by the tool state computing unit 103 of the control device 100 is described with reference to FIG. 4. This process is a simulation process for computing, based on a known gear creation theory, a track of the cutting blade 42af of the first machining tool 42F. Therefore, actual machining is unnecessary. A cost reduction can be achieved. The same applies to the second machining tool 42L and the third machining tool 42R. Detailed explanation of the process is omitted.

The tool state computing unit 103 of the control device 100 reads a tool state such as the axial direction position of the first machining tool 42F in cutting the left tapered tooth flank 121 from the memory 105 (step S31 in FIG. 4). The tool state computing unit 103 stores “1 (indicating first time)” as the number of times of simulation n in the memory 105 (step S32 in FIG. 4) and sets the first machining tool 42F to the read tool state (step S33 in FIG. 4).

The tool state computing unit 103 calculates, based on the shape data of the first machining tool 42F read from the memory 105, a tool track in machining the left tapered tooth flank 121 (step S34 in FIG. 4) and calculates a shape of the left tapered tooth flank 121 after machining (step S35 in FIG. 4). Then, the tool state computing unit 103 compares the calculated shape of the left tapered tooth flank 121 after the machining and the shape of the left tapered tooth flank 121 in design, calculates a shape error, and stores the calculated shape error in the memory 105 (step S36 in FIG. 4). The tool state computing unit 103 adds 1 to the number of times of simulation n (step S37 in FIG. 4).

The tool state computing unit 103 determines whether the number of times of simulation n reaches a preset number of times nn (step S38 in FIG. 4). When the number of times of simulation n does not reach the preset number of times nn, the tool computing unit 103 changes the tool state of the first machining tool 42F, for example, the axial direction position of the first machining tool 42F (step S39 in FIG. 4), returns to step S34, and repeats the process described above. On the other hand, when the number of times of simulation n reaches the preset number of times nn, the tool state computing unit 103 selects the axial direction position of the first machining tool 42F having a minimum error among stored shape errors, stores the selected axial direction position in the memory 105 (step S40 in FIG. 4), and ends the entire process.

In the process described above, the simulation is performed a plurality of times and the axial direction position of the first machining tool 42F having the minimum error is selected. However, it is also possible to set an allowable shape error in advance and select the axial direction position of the first machining tool 42F at the time when the shape error calculated in step S36 is equal to or smaller than the allowable shape error. In the step S39, instead of changing the axial direction position of the first machining tool 42F, it is also possible to change the intersection angle ϕf of the first machining tool 42F or change the position of the first machining tool 42F about the axis, or change any combination of the intersection angle, the axial direction position, and the position about the axis.

### 1-6. Process by the Machining Control Unit of the Control Device

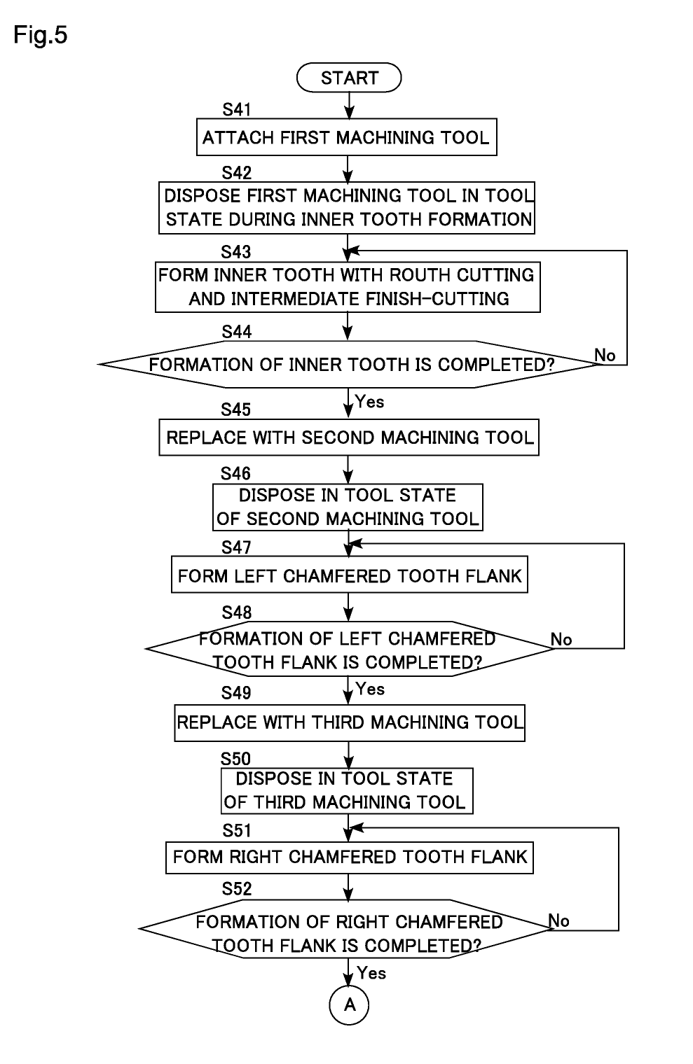

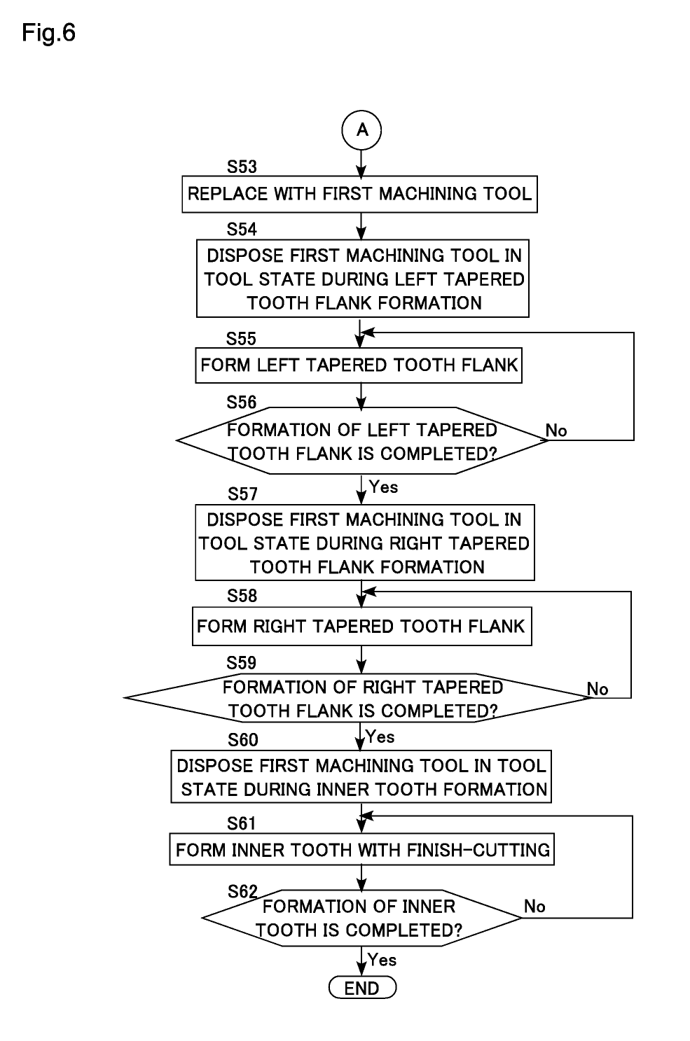

A process (a gear machining method) by the machining control unit 101 of the control device 100 is described with reference to FIGS. 5 and 6. It is assumed here that the operator manufactures, based on the respective shape data of the first machining tool 42F, the second machining tool 42L, and the third machining tool 42R designed by the tool design unit 102, the first machining tool 42F, the second machining tool 42L, and the third machining tool 42R and disposes the first machining tool 42F, the second machining tool 42L, and the third machining tool 42R in an automatic tool replacement device in the machining device 1. It is also assumed that the sleeve 115 is attached to the workpiece holder 80 of the machining device 1.

The machining control unit 101 of the control device 100 attaches the first machining tool 42F to the rotary spindle 40 with the automatic tool replacement device (step S41 in FIG. 5). The machining control unit 101 disposes the first machining tool 42F and the sleeve 115 such that a tool state of the first machining tool 42F for cutting the left tooth flank 115b and the right tooth flank 115c of the inner tooth 115a on the inner circumference of the sleeve 115 with the first machining tool 42F calculated by the tool state computing unit 103 is achieved (step S42 in FIG. 5).

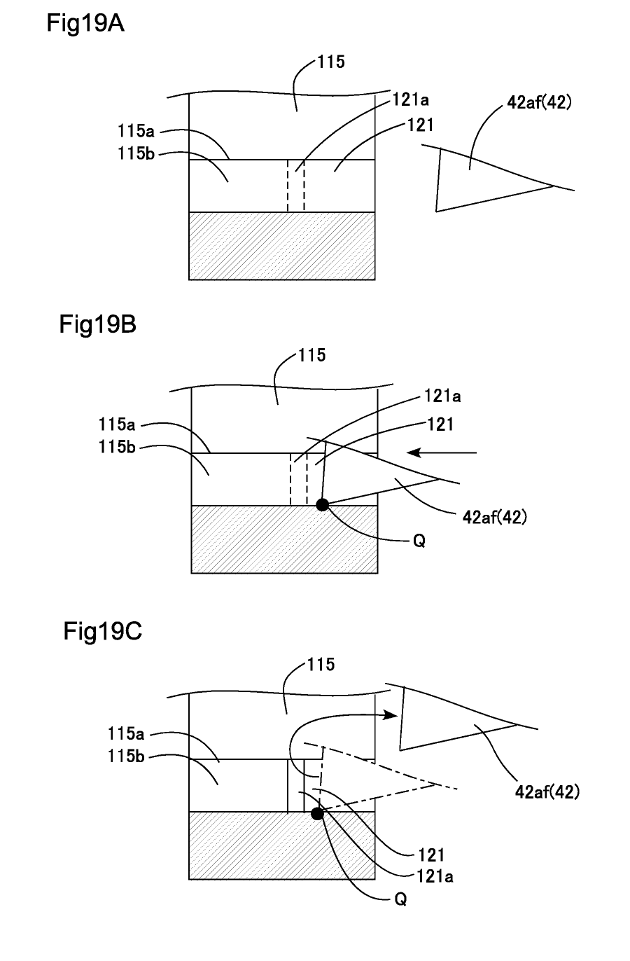

The machining control unit 101 feeds the first machining tool 42F in the direction of the rotation axis Lw of the sleeve 115 once or a plurality of times while rotating the first machining tool 42F synchronously with the sleeve 115 and roughly cuts the inner circumference of the sleeve 115 to form the left tooth flank 115b and the right tooth flank 115c of the inner tooth 115a. Further, the machining control unit 101 intermediately finish-cuts the formed left tooth flank 115b and the formed right tooth flank 115c of the inner tooth 115a (step S43 in FIG. 5; equivalent to “first step” of the invention). The intermediate finish-cutting is performed by setting tool feeding speed lower than tool feeding speed during the rough cutting. As illustrated in FIG. 18A, burrs B1 are formed at end portions on a cutting end side of the first machining tool 42F in the left tooth flank 115b and the right tooth flank 115c of the inner tooth 115a by the intermediate finish-cutting.

When the cutting of the left tooth flank 115b and the right tooth flank 115c is completed (step S44 in FIG. 5), the machining control unit 101 replaces, with the automatic tool replacement device, the first machining tool 42F with the second machining tool 42L (step S45 in FIG. 5). The machining control unit 101 disposes the second machining tool 42L and the sleeve 115 such that a tool state of the second machining tool 42L for cutting the left chamfered tooth flank 131 on the left tooth flank 115b of the inner tooth 115a with the second machining tool 42L calculated by the tool state computing unit 103 is achieved (step S46 in FIG. 5). The machining control unit 101 feeds the second machining tool 42L in the direction of the rotation axis Lw of the sleeve 115 once or a plurality of times while rotating the second machining tool 42L synchronously with the sleeve 115 and cuts the inner tooth 115a to form the left chamfered tooth flank 131 on the left tooth flank 115b of the inner tooth 115a (step S47 in FIG. 5; equivalent to “second step” of the invention).

When the cutting of the left chamfered tooth flank 131 is completed (step S48 in FIG. 5), the machining control unit 101 replaces, with the automatic tool replacement device, the second machining tool 42L with the third machining tool 42R (step S49 in FIG. 5). The machining control unit 101 disposes the third machining tool 42R and the sleeve 115 such that a tool state of the third machining tool 42R for cutting the right chamfered tooth flank 132 on the right tooth flank 115c of the inner tooth 115a with the third machining tool 42R calculated by the tool state computing unit 103 is achieved (step S50 in FIG. 5).

The machining control unit 101 feeds the third machining tool 42R in the direction of the rotation axis Lw of the sleeve 115 once or a plurality of times while rotating the third machining tool 42R synchronously with the sleeve 115 and cuts the right tooth flank 115c of the inner tooth 115a to form the right chamfered tooth flank 132 on the right tooth flank 115c of the inner tooth 115a (step S51 in FIG. 5; equivalent to “second step” of the invention). The machining control unit 101 may cut the left chamfered tooth flank 131 after cutting the right chamfered tooth flank 132. By the cutting, as illustrated in FIG. 18B, burrs B2 are formed at end portions on a cutting end side of the second machining tool 42L in the left chamfered tooth flank 131 and a cutting end side of the third machining tool 42R in the right chamfered tooth flank 132.

When the cutting of the right chamfered tooth flank 132 is completed (step S52 in FIG. 5), the machining control unit 101 replaces, with the automatic tool replacement device, the third machining tool 42R with the first machining tool 42F (step S53 in FIG. 6). The machining control unit 101 disposes the first machining tool 42F and the sleeve 115 such that a tool state of the first machining tool 42F for cutting the left tapered tooth flank 121 including the left sub-tooth flank 121a with the first machining tool 42F calculated by the tool state computing unit 103 is achieved (step S54 in FIG. 6). The machining control unit 101 feeds the first machining tool 42F in the direction of the rotation axis Lw of the sleeve 115 once or a plurality of times while rotating the first machining tool 42F synchronously with the sleeve 115 and cuts the inner tooth 115a to form the left tapered tooth flank 121 including the left sub-tooth flank 121a (step S55 in FIG. 6; equivalent to “third step” of the invention).

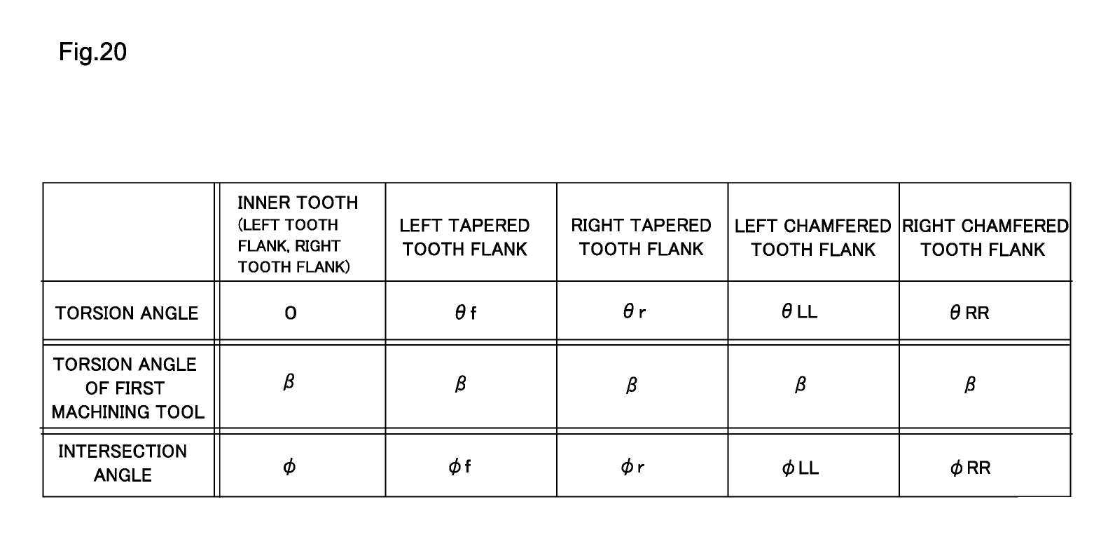

That is, as illustrated in FIGS. 19A to 19C, the first machining tool 42F performs a cutting operation in the direction of the rotation axis Lw of the sleeve 115 once or a plurality of times to form the left tapered tooth flank 121 including the left sub-tooth flank 121a in the inner tooth 115a. The first machining tool 42F at this time needs to perform a feeding operation and a returning operation in the opposite direction from the feeding operation. However, as illustrated in FIG. 19C, an inertial force acts in this reversing operation. Therefore, the feeding operation of the first machining tool 42F ends at a point Q, which is shorter by a predetermined length than the tooth trace length ff of the left tapered tooth flank 121 that can form the left tapered tooth flank 121 including the left sub-tooth flank 121a, and shifts to the returning operation. The feed end point Q can be calculated by measurement with a sensor or the like. However, if the feeding amount is sufficiently accurate with respect to necessary machining accuracy, the point Q can be adjusted by the feeding amount without being measured. That is, accurate machining can be achieved by performing cutting work while adjusting the feeding amount such that machining can be performed up to the point Q.

When the cutting of the left tapered tooth flank 121 is completed (step S56 in FIG. 6), the machining control unit 101 disposes the first machining tool 42F and the sleeve 115 such that a tool state of the first machining tool 42F for cutting the right tapered tooth flank 122 including the right sub-tooth flank 122a calculated by the tool state computing unit 103 is achieved (step S57 in FIG. 6). The machining control unit 101 feeds the first machining tool 42F in the direction of the rotation axis Lw of the sleeve 115 once or a plurality of times while rotating the first machining tool 42F synchronously with the sleeve 115 and cuts the inner tooth 115a to form the right tapered tooth flank 122 including the right sub-tooth flank 122a (step S58 in FIG. 6; equivalent to “third step” of the invention).

The machining control unit 101 may cut the left tapered tooth flank 121 after cutting the right tapered tooth flank 122. By the cutting, as illustrated in FIG. 18C, the burrs B2 formed on the left chamfered tooth flank 131 and the right chamfered tooth flank 132 are removed and burrs B3 are formed at end portions on a cutting end side of the first machining tool 42F in the left tapered tooth flank 121 and the right tapered tooth flank 122.

When the cutting of the right tapered tooth flank 122 is completed (step S59 in FIG. 6), the machining control unit 101 disposes the first machining tool 42F and the sleeve 115 such that a tool state of the first machining tool 42F for finish-cutting the intermediately finish-cut inner tooth 115a calculated by the tool state computing unit 103 is achieved (step S60 in FIG. 6). The machining control unit 101 feeds the first machining tool 42F in the direction of the rotation axis Lw of the sleeve 115 once while rotating the first machining tool 42F synchronously with the sleeve 115 and finish-cuts the left tooth flank 115b and the right tooth flank 115c of the inner tooth 115a (step S61 in FIG. 6; equivalent to “fourth step” of the invention). The finish-cutting is performed by setting tool feeding speed lower than tool feeding speed during the intermediate finish-cutting.

When the finish-cutting of the left tooth flank 115b and the right tooth flank 115c of the inner tooth 115a is completed (step S62 in FIG. 6), the machining control unit 101 ends the entire process. By the finish-cutting, as illustrated in FIG. 18D, the burrs B1 formed on the left tooth flank 115b and the right tooth flank 115c of the inner tooth 115a and the burrs B3 formed on the left tapered tooth flank 121 and the right tapered tooth flank 122 are removed. Although burrs are formed even after the finish-cutting, because the burrs are extremely small, the burrs can be removed by a post-process (e.g., brushing).

As described above, in the machining device 1, first, the inner tooth 115a of the sleeve 115 is roughly cut and intermediately finish-cut and, subsequently, the left chamfered tooth flank 131 and the right chamfered tooth flank 132 of the gear coming-off preventing section 120 are cut. Subsequently, the left tapered tooth flank 121 and the right tapered tooth flank 122 of the gear coming-off preventing section 120 are cut. Finally, the inner tooth 115a of the sleeve 115 is finish-cut. Consequently, burrs formed in the cutting processes can be generally removed.

If the left tapered tooth flank 121 and the right tapered tooth flank 122 are cut and then the left chamfered tooth flank 131 and the right chamfered tooth flank 132 are cut, in the finish-cutting, there is no chance of bringing the inner tooth 115a into contact with the left chamfered tooth flank 131 and the right chamfered tooth flank 132. Therefore, burrs formed in the left chamfered tooth flank 131 and the right chamfered tooth flank 132 cannot be removed. As described above, the gear coming-off preventing section 120 can be formed by only cutting and formed burrs can be removed simultaneously with the cutting. Therefore, it is possible to more greatly reduce a machining time of the rolling, the end milling, and the punching than in the past.

### 1-7. Another Example of the Machining Tool

In the example described above, the cutting of the gear coming-off preventing section 120 of the sleeve 115 is performed as described below using the three machining tools, that is, the first machining tool 42F, the second machining tool 42L, and the third machining tool 42R as illustrated in FIG. 7. That is, the cutting is performed by changing the intersection angles ϕ, ϕf, ϕr, ϕL, and ϕR. The intersection angles ϕ, ϕf, ϕr, ϕL, and ϕR represented by the differences between the torsion angles 0° and 0° of the left tooth flank 115b and the right tooth flank 115c of the inner tooth 115a, the torsion angles θf and θr of the left tapered tooth flank 121 including the left sub-tooth flank 121a and the right tapered tooth flank 122 including the right sub-tooth flank 122a, the torsion angles θL and θR of the left chamfered tooth flank 131 and the right chamfered tooth flank 132 and the torsion angles β, βL, and βR of cutting blades 42aF, 42aL, and 42aR.

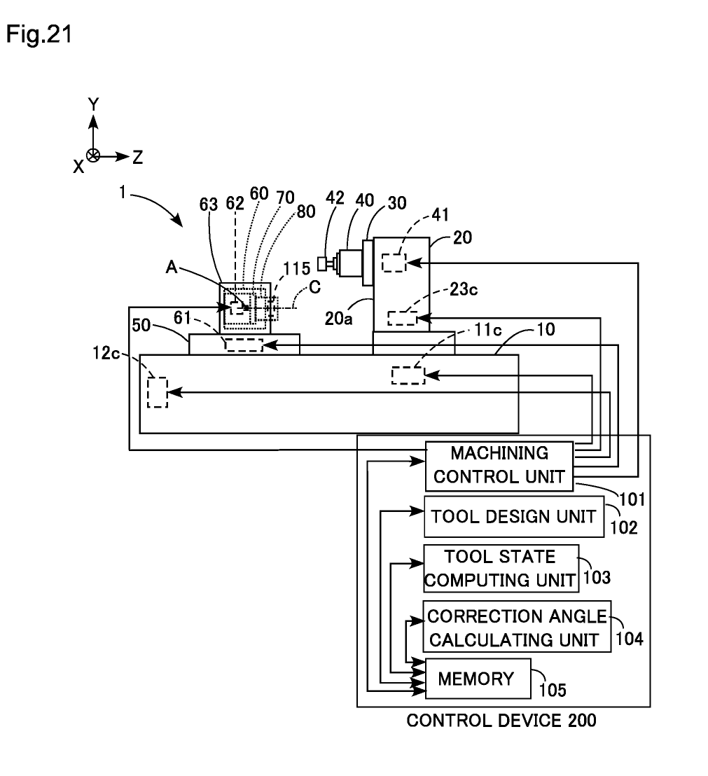

However, as illustrated in FIG. 20, the inventor found that all the tooth flanks sometimes can be cut by only the first machining tool 42F. As a condition in this case, intersection angles ϕLL and ϕRR in cutting the left chamfered tooth flank 131 and the right chamfered tooth flank 132 with the first machining tool 42F need to be able to be set by the machining device 1. That is, the intersection angles ϕLL and ϕRR are differences between the torsion angle β of the first machining tool 42F and torsion angles ϕLL and ϕRR of the left chamfered tooth flank 131 and the right chamfered tooth flank 132. The intersection angles ϕLL and ϕRR only have to be able to be set based on the torsion angles β, θLL, and θRR. That is, when the torsion angles θLL and θRR of the left chamfered tooth flank 131 and the right chamfered tooth flank 132 are predetermined values, all the tooth flanks 115b, 115c, 121, 122, 131, and 132 can be cut by only the first machining tool 42F. It is possible to more greatly reduce the machining time because tool replacement is unnecessary.

### 1-8. Others

In the example described above, the machining is performed on the inner circumferential tooth. However, the machining can also be performed on an outer circumferential tooth. The workpiece is the sleeve 115 of the synchromesh mechanism 110. However, the workpiece may be a workpiece including a tooth section that meshes like a gear, a cylindrical workpiece, or a disk-shaped workpiece. A plurality of tooth flanks (having a different plurality of tooth traces or tooth shapes (tooth tips and tooth roots)) can be machined in the same manner on one or both of the inner circumference (the inner tooth) and the outer circumference (the outer tooth). Continuously changing tooth traces and tooth shapes (tooth tips and tooth roots) such as crowning and relieving can also be machined in the same manner. Meshing can be optimized (performed in a satisfactory state).

In the example described above, the machining device 1, which is a five-axis machining center, is capable of turning the sleeve 115 about the A axis. On the other hand, the five-axis machining center may be configured as a vertical machining center to be capable of turning the machining tools 42F, 42R, and 42 about the A axis. In the above description, the invention is applied to the machining center. However, the invention can also be applied to a machine specific for gear machining.

### Second Embodiment

### 2-1. Mechanical Configuration of a Machining Device

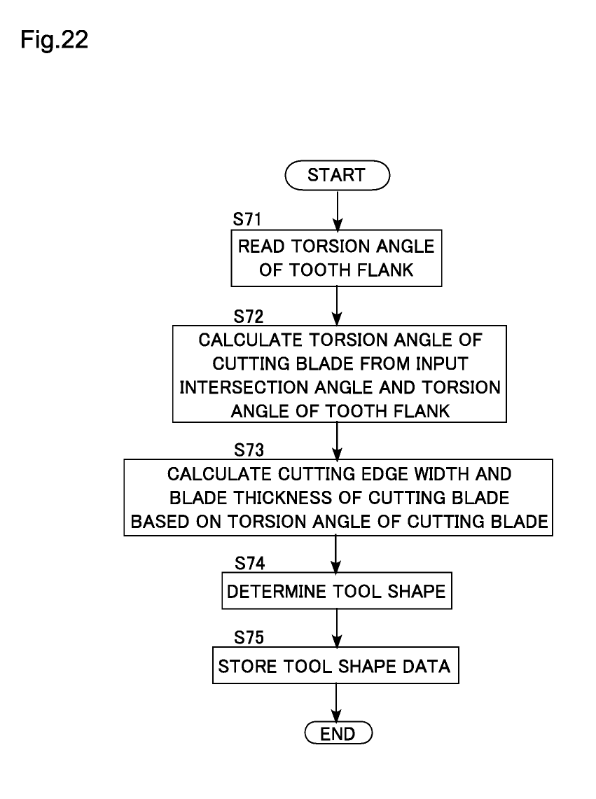

A mechanical configuration of the machining device 1 in a second embodiment illustrated in FIG. 21 is the same as the mechanical configuration of the machining device 1 in the first embodiment illustrated in FIG. 1. However, a control configuration of a control device 200 of the machining device 1 in the second embodiment is different from the control configuration of the control device 100 of the machining device 1 in the first embodiment. In FIG. 21, the same components as the components illustrated in FIG. 1 are denoted by the same reference numerals and signs. Detailed description of the components is omitted.

As illustrated in FIG. 21, the control device 200 includes the machining control unit 101, the tool design unit 102, the tool state computing unit 103, a correction angle calculating unit 104, and the memory 105.

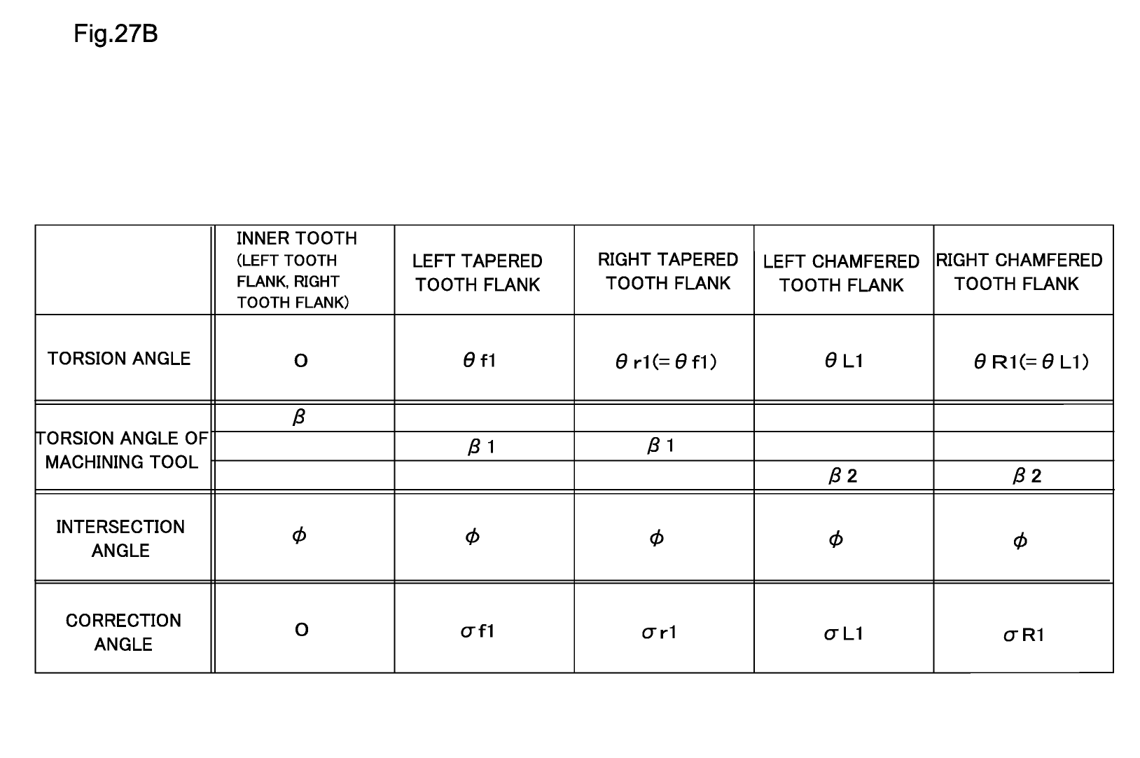

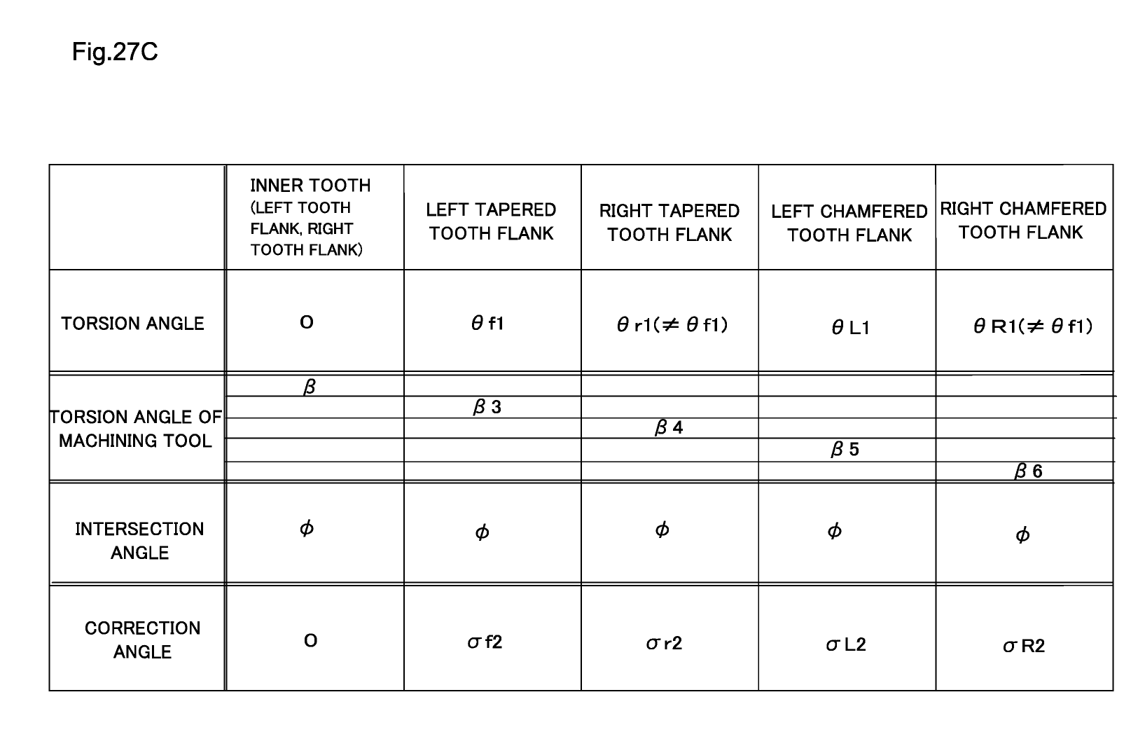

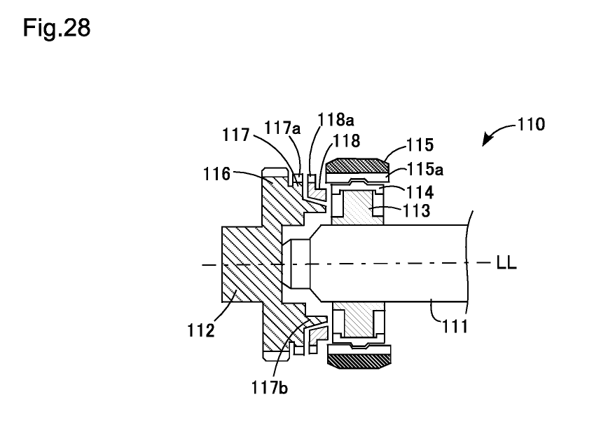

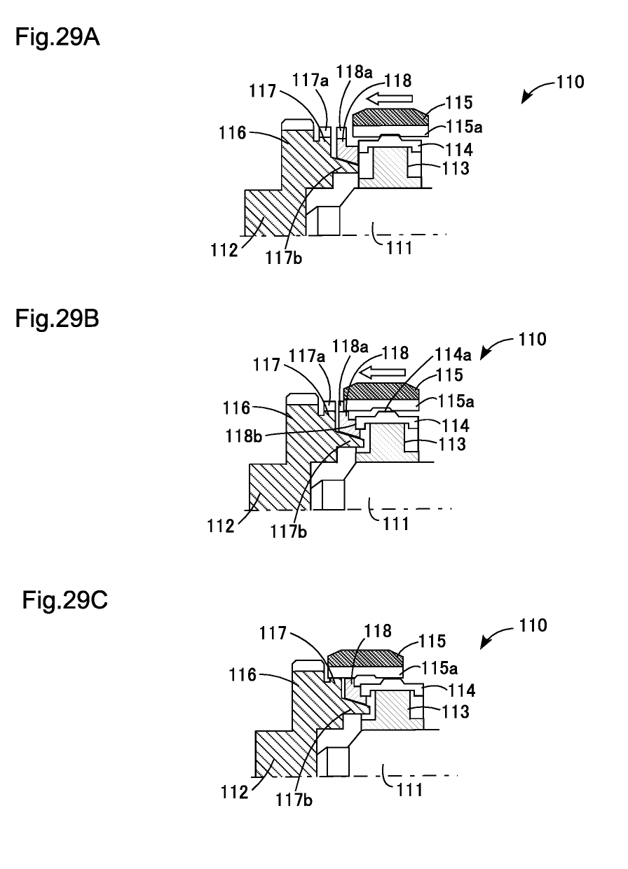

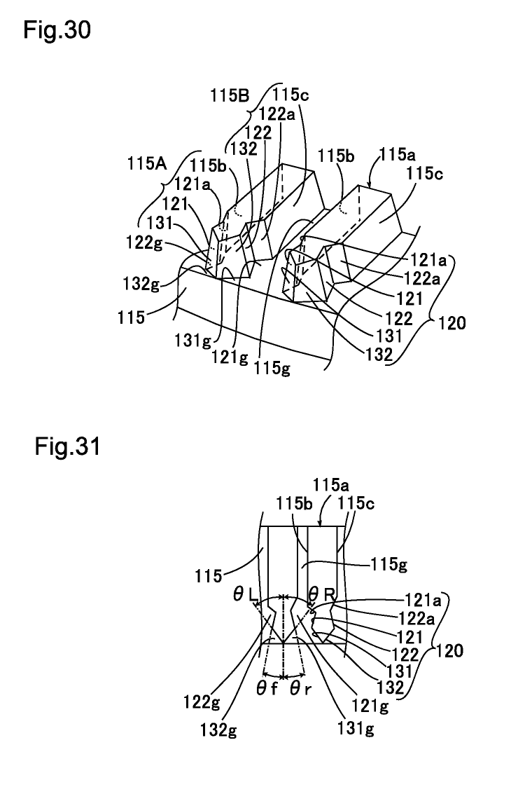

As described in detail below, when a rotation phase of the machining tool 42 and the sleeve 115 during synchronous rotation when cutting the tooth flanks 115b and 115c (both side wall sections of the tooth groove 115g) of the inner tooth 115a of the sleeve 115 is set as a reference rotation phase (0 degree), the correction angle calculating unit 104 calculates correction angles σf, σr, σL, and σR (see FIG. 27A) with respect to the reference rotation phase (0 degree) of the machining tool 42 and the sleeve 115 in cutting the chamfered tooth flanks 131 and 132 of the gear coming-off preventing section 120 (both side wall sections of the chamfered tooth grooves 131g and 132g) and the tapered tooth flanks 121 and 122 (both side wall sections of the tapered tooth grooves 121g and 122g) of the gear coming-off preventing section 120.

In the memory 105, tool data relating to the machining tool 42, that is, the cutting edge circle diameter da, the reference circle diameter d, the addendum ha, the module m, the addendum modification coefficient λ, the pressure angle α, the front pressure angle αt, and the cutting edge pressure angle αa as well as machining data for cutting the sleeve 115 are stored in advance. The memory 105 stores, for example, a number of blades Z of the cutting blade 42a input when designing the machining tool 42. The memory 105 stores shape data of the machining tool 42 designed by the tool design unit 102 and a tool state computed by the tool state computing unit 103. The memory 105 stores the correction angles σf , σr, σL, and σR of the rotation phase of the sleeve 115 calculated by the correction angle calculating unit 104.

### 2-2. Machining Tool

Designing of the machining tool 42 used in the machining device 1 in the second embodiment is described. The designing of the machining tool 42 is substantially the same as the content described in the first embodiment. Therefore, the designing is described below with reference to FIGS. 8A to 8C and 10 (signs in parentheses in the figure correspond to the second embodiment). The machining tool 42 is designed based on the shapes of the left tooth flank 115b and the right tooth flank 115c of the inner tooth 115a. As illustrated in FIG. 8A, the cutting blade 42a when viewing the machining tool 42 from the tool end surface 42 side in the direction of the tool axis (rotation axis) L has the same shape as the involute curve in this example.

As illustrated in FIG. 8B, the cutting blade 42a of the machining tool 42 has a rake angle inclined by the angle γ with respect to a plane perpendicular to the tool axis L on the tool end surface 42 side and a front clearance angle inclined by the angle δ with respect to a straight line parallel to the tool axis L on a tool peripheral surface 42B side. As illustrated in FIG. 8C, blade traces 42b of the cutting blade 42a have a torsion angle inclined by the angle β with respect to a straight line parallel to the tool axis L.

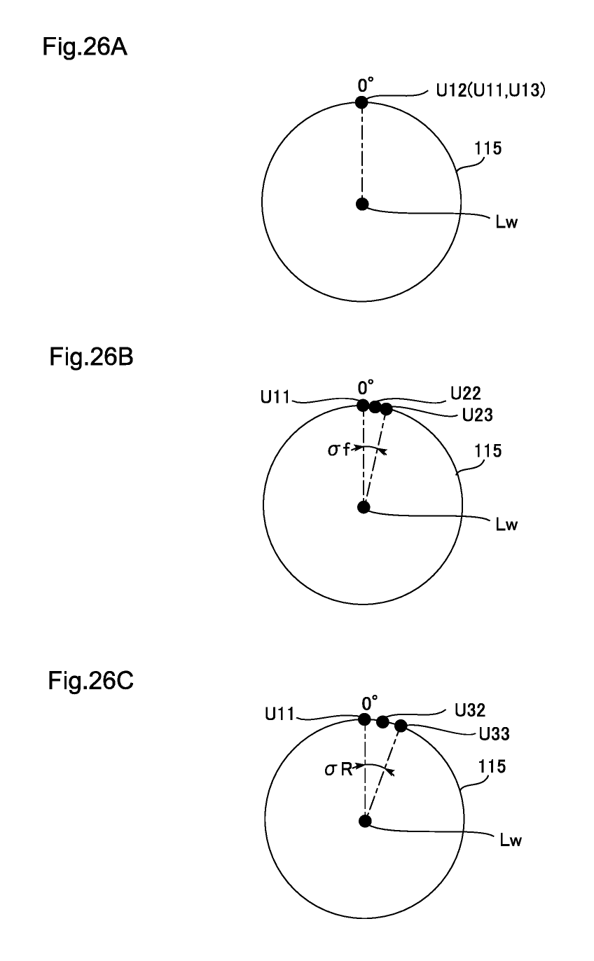

For the designing of the cutting blade 42a, first, the torsion angle β of the cutting blade 42a is calculated from a sum of torsion angles of the left tooth flank 115b and the right tooth flank 115c (the tooth groove 115g) of the inner tooth 115a and the intersection angle ϕ (see FIG. 25A). In this example, because the torsion angles of the left tooth flank 115b and the right tooth flank 115c (the tooth groove 115g) are 0 degree, the torsion angle β of the cutting blade 42a is the same as the intersection angle ϕ.

Subsequently, a cutting edge width Sa (see FIG. 10) of the cutting blade 42a and a blade thickness Ta (see FIG. 10) on a reference circle Cb (see FIG. 10) of the cutting blade 42a are calculated. According to the process described above, the machining tool 42 including the optimum cutting blade 42a for cutting the left tooth flank 115b and the right tooth flank 115c (the tooth groove 115g) is designed. An example of computation for calculating the cutting edge width Sa of the cutting blade 42a and the blade thickness Ta on the reference circle Cb of the cutting blade 42a is described below.

As illustrated in FIG. 10, the cutting edge width Sa of the cutting blade 42a is represented by the cutting edge circle diameter da and a half angle ψa of the blade thickness of the cutting edge circle (see Expression (11)).

Expression 11

Sa=ψa·da (11)

The cutting edge circle diameter da is represented by the reference circle diameter d and the addendum ha (see Expression (12)). Further, the reference circle diameter d is represented by the number of blades Z of the cutting blade 42a, the torsion angle β of blade traces 42b of the cutting blade 42a, and the module m (see Expression (13)). The addendum ha is represented by an addendum modification coefficient λ and the module m (see Expression (14)).

Expression 12

da=d+2·ha (12)

Expression 13

d=Z·m/cos β (13)

Expression 14

ha=2·m(1+λ) (14)

The half angle ψa of the blade thickness of the cutting edge circle is represented by the number of blades Z of the cutting blade 42a, the addendum modification coefficient λ, the pressure angle α, the front pressure angle αt, and the cutting edge pressure angle αa (see Expression (15)). The front pressure angle αt can be represented by the pressure angle α and the torsion angle β of the blade traces 42b of the cutting blade 42a (see Expression (16)). The cutting edge pressure angle αa can be represented by the front pressure angle αt, the cutting edge circle diameter da, and the reference circle diameter d (see Expression (17)).

Expression 15

ψa=π/(2·Z)+2·λ·tan α/Z+(tan αt−αt)−(tan αa−αa) (15)

Expression 16

αt=tan⁻¹(tan α/cos β) (16)

Expression 17

αa=cos⁻¹(d·cos αt/da) (17)

The blade thickness Ta of the cutting blade 42a is represented by the reference circle diameter d and the half angle ψ of the blade thickness Ta (see Expression (18)).

Expression 18

Ta=ψ·d (18)

The reference circle diameter d is represented by the number of blades Z of the cutting blade 42a, the torsion angle β of the blade traces 42b of the cutting blade 42a, and the module m (see Expression (19)).

Expression 19

d=Z·m/cos β (19)

The half angle ψf of the blade thickness Ta is represented by the number of blades Z of the cutting blade 42a, the addendum modification coefficient λ, and the pressure angle α (see Expression (20)). The designing of the machining tool 42 described above is performed in the tool design unit 102 of the control device 100. Details of the process are described below.

Expression 20

ψ=π/(2·Z)+2·λ·tan α/Z (20)

### 2-3. Correction Angle of the Rotation Phase

As described in Background Art, the machining of the sleeve 115 includes various kinds of machining. To further improve machining accuracy, a separate process for removing formed burrs is necessary. Therefore, a machining time tends to be long. In the machining device 1 described above, the rotation axis Lw of the sleeve 115 is inclined at the intersection angle ϕ with respect to the rotation axis L of the machining tool 42. The machining tool 42 is fed in the direction of the rotation axis Lw of the sleeve 115 while being rotated synchronously with the sleeve 115. The tooth flanks 115b and 115c (the tooth groove 115g) of the inner tooth 115a of the sleeve 115 is cut. A rotation phase of the machining tool 42 and the sleeve 115 during the synchronous rotation at this time is set as a reference rotation phase (0 degree).

The inventor found that it is possible to cut, with one machining tool 42, the left and right chamfered tooth flanks 131 and 132 (the left and right chamfered tooth grooves 131g and 132g) of the gear coming-off preventing section 120 and the left and right tapered tooth flanks 121 and 122 (the left and right tapered tooth grooves 121g and 122g) of the gear coming-off preventing section 20 by correcting the rotation phase of the machining tool 42 and the sleeve 115 during the synchronous rotation with the correction angles σf, σr, σL, and σR (see FIG. 27A) with respect to the reference rotation phase (0 degree). The cutting is described below.

As described above, the machining tool 42 has the torsion angles of the left tooth flank 115b and the right tooth flank 115c (the tooth groove 115g) and the torsion angle β of the blade traces 42b of the cutting blade 42a corresponding to 0 degree in this example to enable cutting of the left tooth flank 115b and the right tooth flank 115c (the tooth groove 115g) of the inner tooth 115a. When such a machining tool 42 is rotating synchronously with the sleeve 115 at the intersection angle ϕ, as illustrated in FIG. 25A, a cutting edge 42c of the cutting blade 42a when cutting the left tooth flank 115b takes a linear moving track ML1 parallel to the rotation axis Lw of the sleeve 115 reaching a cutting completion position U13 (the other end (the upper end in the figure) of the left tooth flank 115b) from a predetermined approach position U11 through a cutting start position U12 (one end (the lower end in the figure) of the left tooth flank 115b). The approach position U11 is a predetermined position on a straight line extending in a tooth brace direction of the left tooth flank 115b from the cutting start position U12 to the machining tool 42 side.

In view of the points described above, to cut the left tapered tooth flank 121 (the left tapered tooth groove 121g) at a fixed intersection angle ϕ with the same machining tool 42, the following process is performed. That is, the synchronous rotation of the machining tool 42 and the sleeve 115 only has to be controlled such that a moving track ML2 of the cutting edge 42c of the cutting blade 42a linearly reaches a cutting completion position U23 (the other end (the upper end in the figure) of the left tapered tooth flank 121) from the approach position U11 through a cutting start position U22 (one end (the lower end in the figure) of the left tapered tooth flank 121) as illustrated in FIG. 25B. That is, the approach position U11 only has to be located on a straight line extending in a tooth trace direction of the left tapered tooth flank 121 from the cutting start position U22 to the machining tool 42 side. The moving track ML2 at this time is parallel to a straight line inclined by the torsion angle θf of the left tapered tooth flank 121 with respect to the rotation axis Lw of the sleeve 115. The same applies when the right tapered tooth flank 122 (the right tapered tooth groove 122g) is cut.

Similarly, to cut the right chamfered tooth flank 132 (the right chamfered tooth groove 132g) at the fixed intersection angle ϕ with the same machining tool 42, the synchronous rotation of the machining tool 42 and the sleeve 115 only has to be controlled such that a moving track ML3 of the cutting edge 42c of the cutting blade 42a linearly reaches a cutting completion position U33 (the other end (the upper end in the figure) of the right chamfered tooth flank 132) from the approach position U11 through a cutting start position U32 (one end (the lower end in the figure) of the right chamfered tooth flank 132) as illustrated in FIG. 25C. That is, the approach position U11 only has to be located on a straight line extending in a tooth trace direction of the right chamfered tooth flank 132 from the cutting start position U32 to the machining tool 42 side. The moving track ML3 is parallel to a straight line inclined by the torsion angle θR of the right chamfered tooth flank 132 with respect to the rotation axis Lw of the sleeve 115. The same applies when the left chamfered tooth flank 131 (the left chamfered tooth groove 131g) is cut.

Consequently, as illustrated in FIG. 25A, when the left tooth flank 115b is cut, because the torsion angle of the left tooth flank 115b is 0, the cutting edge 42c of the cutting blade 42a does not move in the radial direction of the sleeve 115 to reach the cutting completion position U13 from the approach position U11 through the cutting start position U12. On the other hand, as illustrated in FIGS. 25B and 25C, when the left tapered tooth flank 121 and the right chamfered tooth flank 132 are cut, because the torsion angles of the left tapered tooth flank 121 and the right chamfered tooth flank 132 are θf and θR, the cutting edge 42c of the cutting blade 42a moves in the radial direction of the sleeve 115 by distances Ml and M2 to reach the cutting completion positions U23 and U33 from the approach position U11 through the cutting start positions U22 and U32.

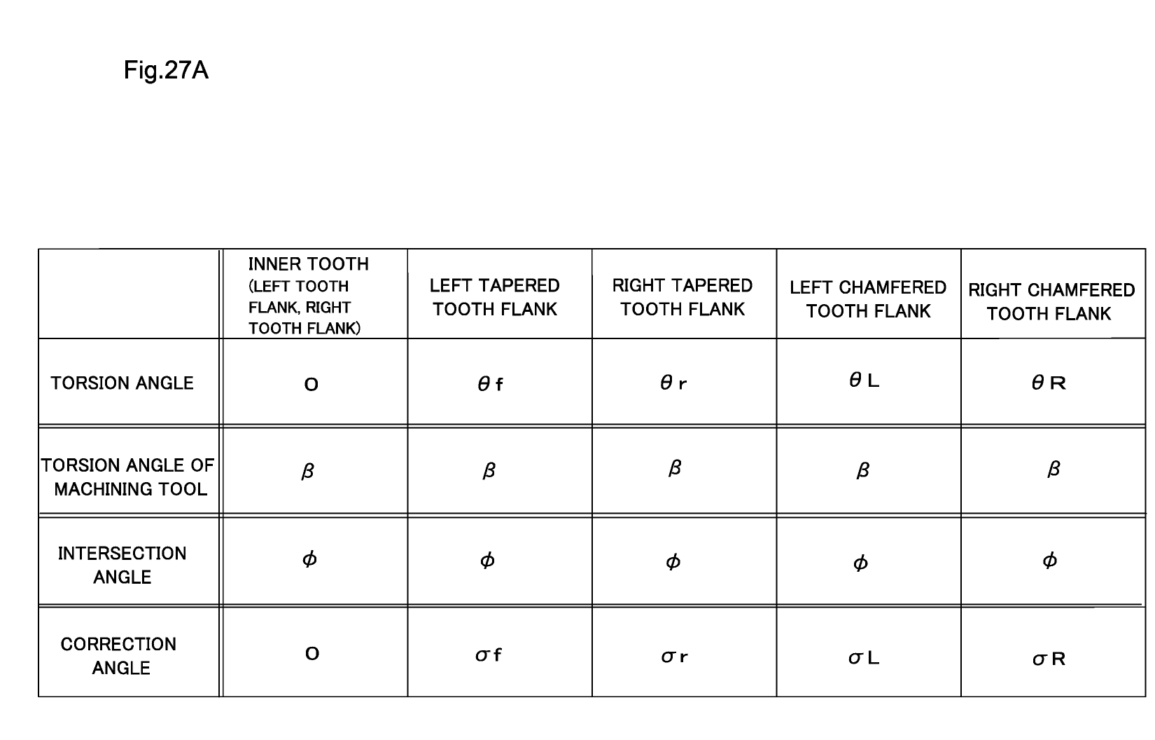

Therefore, as illustrated in FIGS. 25A and 26A, a rotation phase of the machining tool 42 and the sleeve 115 during the synchronous rotation when cutting the left tooth flank 115b, that is, a rotation phase at the time when the approach position U11, the cutting start position U12, and the cutting completion position U13 are present on a straight line parallel to the rotation axis Lw of the sleeve 115 is set as a reference rotation phase (0 degree). As illustrated in FIGS. 25B, 26B, 25C, and 26C, a rotation phase of the machining tool 42 and the sleeve 115 during the synchronous rotation when cutting the left tapered tooth flank 121 and the right chamfered tooth flank 132 is corrected by a rotation phase (the correction angles σf and σR) of the sleeve 115 corresponding to the moving distances Ml and M2 in the radial direction of the sleeve 115 with respect to the reference rotation phase (0 degree). Consequently, it is possible to move the cutting edge 42c of the cutting blade 42a on the moving tracks ML2 and ML3 described above.

The correction angles σf and σR are represented by Expression (21) and Expression (22) described below using a sum of first distances M11 and M21 from the approach position U11 to the cutting start positions U22 and U32 and second distances M12 and M22 from the cutting start positions U22 and U32 to the cutting completion positions U23 and U33 and the torsion angles θf and θR of the left tapered tooth flank 121 and the right chamfered tooth flank 132.

Expression 21

σf=(M11+M12)·sin θf·360/π·Z·m (21)

Expression 22

σR=(M21+M22)·sinθR·360/π·Z·m (22)

Cutting is performed by controlling the synchronous rotation of the machining tool 42 and the sleeve 115 to shift by the correction angles σf and σR with respect to the reference rotation phase (0 degree) in a state in which the intersection angle ϕ is fixed. The synchronous rotation control is enabled by adjusting rotating speed of the machining tool 42 and rotating speed of the sleeve 115. The same applies when the right tapered tooth flank 122 and the left chamfered tooth flank 131 are cut. Consequently, in the machining device 1, it is unnecessary to perform phase matching of the machining tool 42 and the sleeve 115. Further, only cutting by one machining tool 42 has to be performed. Therefore, tool replacement is unnecessary. Removal of formed burrs is also possible. Therefore, it is possible to greatly reduce a machining time.

### 2-4. Tool State of the Machining Tool in the Machining Device

Machining accuracy achieved when the designed machining tool 42 is applied to the machining device 1 in the second embodiment and the left tapered tooth flank 121 is cut by changing a tool state of the machining tool 42 such as a position of the tool in the direction of the tool axis L of the machining tool 42 (hereinafter referred to as axial direction position of the machining tool 42) and the intersection angle ϕ of the machining tool 42 is examined below. The tool state of the machining tool 42 is substantially the same as the content described in the first embodiment. Therefore, the tool state is described below with reference to FIGS. 15A, 15B, 15C to FIGS. 17A, 17B, and 17C (signs in parentheses in the figures correspond to the second embodiment). The same applies to machining accuracy achieved when the left tooth flank 115b, the right tooth flank 115c, the right tapered tooth flank 122, the left chamfered tooth flank 131, and the right chamfered tooth flank 132 of the inner tooth 115a are cut by the machining tool 42. Therefore, detailed description is omitted.

For example, as illustrated in FIG. 15A, the left tapered tooth flank 121 was machined in a state in which the axial direction position of the machining tool 42, that is, an intersection point P between the tool end surface 42A and the tool axis L of the machining tool 42 was located on the rotation axis Lw of the sleeve 115 (offset amount: 0). Further, the left tapered tooth flank 121 was machined in a state in which the intersection point P was offset by a distance +k in the direction of the tool axis L of the machining tool 42 (offset amount: +k). Further, the left tapered tooth flank 121 was machined in a state in which the intersection point P was offset by a distance −k in the direction of the tool axis L of the machining tool 42 (the offset amount: −k). The intersection angle ϕf of the machining tool 42 was fixed in all the states.

As a result, machining states of the left tapered tooth flank 121 were as illustrated in FIGS. 15B, 15C, and 15D. Thick solid lines E in the figures indicate involute curves of the left tapered tooth flank 121 in design converted into straight lines and dot portions D indicate cut and removed portions.

As illustrated in FIG. 15B, with an offset amount of 0, the machined left tapered tooth flank 121 is machined into a shape similar to the involute curve in design. On the other hand, as illustrated in FIG. 15C, with the offset amount +k, the machined left tapered tooth flank 121 is machined into a shape shifted rightward (in the direction of a dotted arrow) in the figure, that is, shifted in a direction of a clockwise pitch circle with respect to the involute curve in design. As illustrated in FIG. 15D, with the offset amount −k, the machined left tapered tooth flank 121 is machined into a shape shifted leftward (in the direction of a dotted arrow) in the figure, that is, shifted in a direction of a counterclockwise pitch circle with respect to the involute curve in design. Therefore, the shape of the left tapered tooth flank 121 can be shifted in the pitch circle direction by changing the position in the tool axis line L direction of the machining tool 42.

For example, as illustrated in FIG. 16A, the left tapered tooth flank 121 was machined in cases where the intersection angle of the machining tool 42 was ϕ, ϕf, and ϕff. A magnitude relation of the angles is ϕ>ϕf>ϕff. As a result, machining states of the left tapered tooth flank 121 were as illustrated in FIGS. 16B, 16C, and 16D.

As illustrated in FIG. 16B, with the intersection angle ϕ, the machined left tapered tooth flank 121 is machined into a shape similar to the involute curve in design. On the other hand, as illustrated in FIG. 16C, with an intersection angle ϕf, the machined left tapered tooth flank 121 is machined into a shape narrowed in width of the tooth tip in a direction of the pitch circle (in the direction of a solid arrow) and widened in width of the tooth root in the direction of the pitch circle (in the direction of the solid arrow) with respect to the involute curve in design. As illustrated in FIG. 16D, with an intersection angle ϕff, the machined left tapered tooth flank 121 is machined into a shape further narrowed in width of the tooth tip in a direction of the pitch circle (in the direction of the solid arrow) and further widened in width of the tooth root in the direction of the pitch circle (in the direction of the solid arrow) with respect to the involute curve in design. Therefore, the shape of the left tapered tooth flank 121 can be changed in width of the tooth tip in the direction of the pitch circle and in width of the tooth root in the direction of the pitch circle by changing the intersection angle of the machining tool 42.

For example, as illustrated in FIG. 17A, the left tapered tooth flank 121 was machined in a state in which the axial direction position of the machining tool 42, that is, the intersection point P between the tool end surface 42A and the tool axis L of the machining tool 42 was located on the rotation axis Lw of the sleeve 115 (offset amount: 0) and the intersection angle of the machining tool 42 was ϕ. Further, the left tapered tooth flank 121 was machined in a state in which the intersection point P was offset by a distance +k in the direction of the tool axis L of the machining tool 42 (offset amount: +k) and the intersection angle was ϕf. As a result, machining states of the left tapered tooth flank 121 were as illustrated in FIGS. 17B and 17C.

As illustrated in FIG. 17B, with the offset amount 0 and the intersection angle ϕ, the machined left tapered tooth flank 121 is machined into a shape similar to the involute curve in design. On the other hand, as illustrated in FIG. 17C, with the offset amount +k and the intersection angle ϕf, the machined left tapered tooth flank 121 is shifted rightward in the figure (in the direction of a dotted arrow), that is, shifted in the clockwise direction of the pitch circle, and is machined into a shape narrowed in width of the tooth tip in the direction of the pitch circle (direction of a solid arrow) and a tooth root widened in width in the direction of the pitch circle (in the direction of the solid arrow) with respect to the involute curve in design. Therefore, the shape of the left tapered tooth flank 121 can be shifted in the direction of the pitch circle by changing the axial direction position of the machining tool 42 and the intersection angle of the machining tool 42. The width of the tooth tip in the circumferential direction and the width of the tooth root in the direction of the pitch circle can be changed.

Consequently, the machining tool 42 can highly accurately cut the left tapered tooth flank 121 by being set with the offset amount of 0 and the intersection angle ϕ in the machining device 1. The tool states of the machining tool 42 are set by the tool state computing unit 103 of the control device 200. Details of the process are described below.

### 2-5. Process by the Tool Design Unit of the Control Device

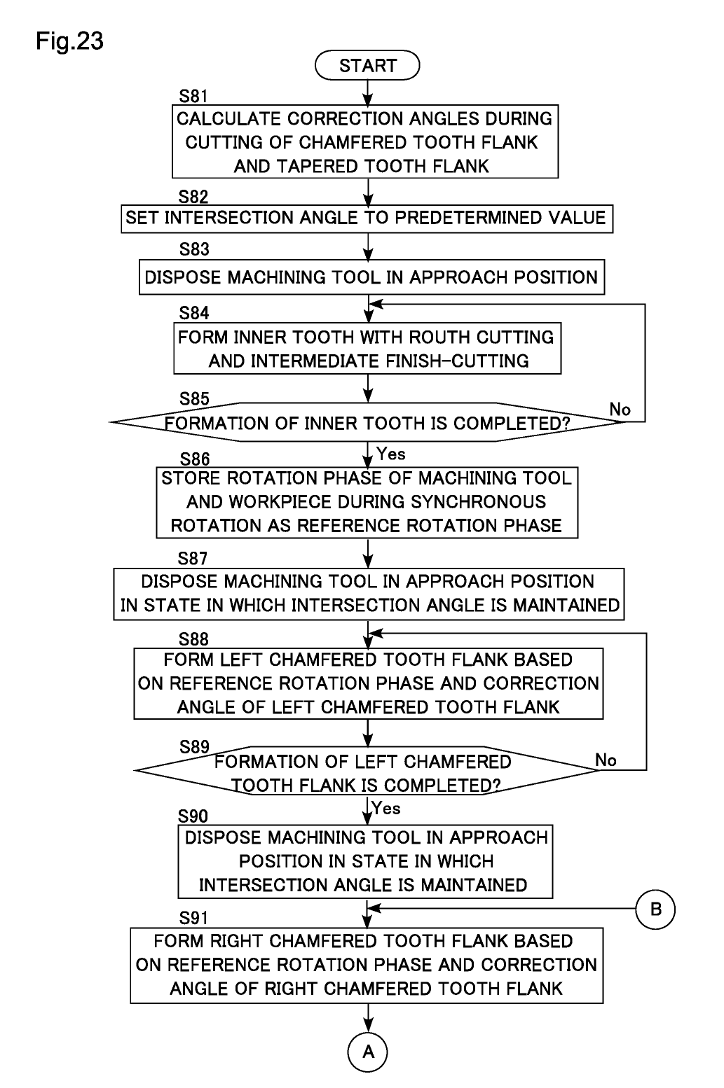

A designing process for the machining tool 42 by the tool design unit 102 of the control device 200 is described with reference to FIGS. 22, 8A, 8B, and 8C. Data relating to the machining tool 42, that is, the number of blades Z, the cutting edge circle diameter da, the reference circle diameter d, the addendum ha, the module m, the addendum modification coefficient λ, the pressure angle α, the front pressure angle αt, and the cutting edge pressure angle αa are assumed to be stored in the memory 105 in advance.

The tool design unit 102 of the control device 200 reads a torsion angle (in this example, 0 degree) of the left tooth flank 115b from the memory 105 (step S71 in FIG. 22). Then, the tool design unit 102 calculates a difference between the intersection angle ϕ of the machining tool 42 in cutting a left tooth flank 115b input by the operator and the read torsion angle (0 degree) of the left tooth flank 115b as the torsion angle β (=ϕ) of the blade traces 42b of the cutting blade 42a of the machining tool 42 (step S72 in FIG. 22).

The tool design unit 102 reads the number of blades Z or the like of the machining tool 42 from the memory 105 and calculates, based on the read number of blades Z or the like of the machining tool 42 and the calculated torsion angle β of the blade traces 42b of the cutting blade 42a, the cutting edge width Sa and the blade thickness Ta of the cutting blade 42a (step S73 in FIG. 22). The tool design unit 102 determines the shape of the machining tool 42 based on, for example, the calculated torsion angle β of the blade traces 42b of the cutting blade 42a (step S74 in FIG. 22). The tool design unit 102 stores determined shape data of the machining tool 42 in the memory 105 (step S75 in FIG. 22) and ends the entire process. Consequently, the machining tool 42 including the optimum cutting blade 42a is designed.

### 2-6. Process by the Tool State Computing Unit of the Control Device

A process by the tool state computing unit 103 of the control device 200 is substantially the same as the content described in the first embodiment. Therefore, the process is described with reference to FIG. 4. This process is a simulation process for computing, based on a known gear creation theory, a track of the cutting blade 42a of the machining tool 42. Therefore, actual machining is unnecessary. A cost reduction can be achieved.

The tool state computing unit 103 of the control device 200 reads a tool state such as the axial direction position of the machining tool 42 in cutting the left tapered tooth flank 121 from the memory 105 (step S31 in FIG. 4). The tool state computing unit 103 stores “1 (indicating first time)” as the number of times of simulation n in the memory 105 (step S32 in FIG. 4) and sets the machining tool 42 to the read tool state (step S33 in FIG. 4).

The tool state computing unit 103 calculates, based on the shape data of the machining tool 42 read from the memory 105, a tool track in machining the left tapered tooth flank 121 (step S34 in FIG. 4) and calculates a shape of the left tapered tooth flank 121 after the machining (step S35 in FIG. 4). Then, the tool state computing unit 103 compares the calculated shape of the left tapered tooth flank 121 after the machining and the shape of the left tapered tooth flank 121 in design, calculates a shape error, and stores the calculated shape error in the memory 105 (step S36 in FIG. 4). The tool state computing unit 103 adds 1 to the number of times of simulation n (step S37 in FIG. 4).

The tool state computing unit 103 determines whether the number of times of simulation n reaches a preset number of times nn (step S38 in FIG. 4). When the number of times of simulation n does not reach the preset number of times nn, the tool computing unit 103 changes the tool state of the machining tool 42, for example, the axial direction position of the machining tool 42 (step S39 in FIG. 4), returns to step S34, and repeats the process described above. On the other hand, when the number of times of simulation n reaches the preset number of times nn, the tool state computing unit 103 selects the axial direction position of the machining tool 42 having a minimum error among stored shape errors, stores the selected axial direction position in the memory 105 (step S40 in FIG. 4), and ends the entire process.

In the process described above, the simulation is performed a plurality of times and the axial direction position of the machining tool 42 having the minimum error is selected. However, it is also possible to set an allowable shape error in advance and select the axial direction position of the machining tool 42 at the time when the shape error calculated in step S36 is equal to or smaller than the allowable shape error. In the step S39, instead of changing the axial direction position of the machining tool 42, it is also possible to change the intersection angle ϕ of the machining tool 42 or change the position of the machining tool about the axis, or change any combination of the intersection angle, the axial direction position, and the position about the axis.

### 2-7. Process by the Machining Control Unit of the Control Device

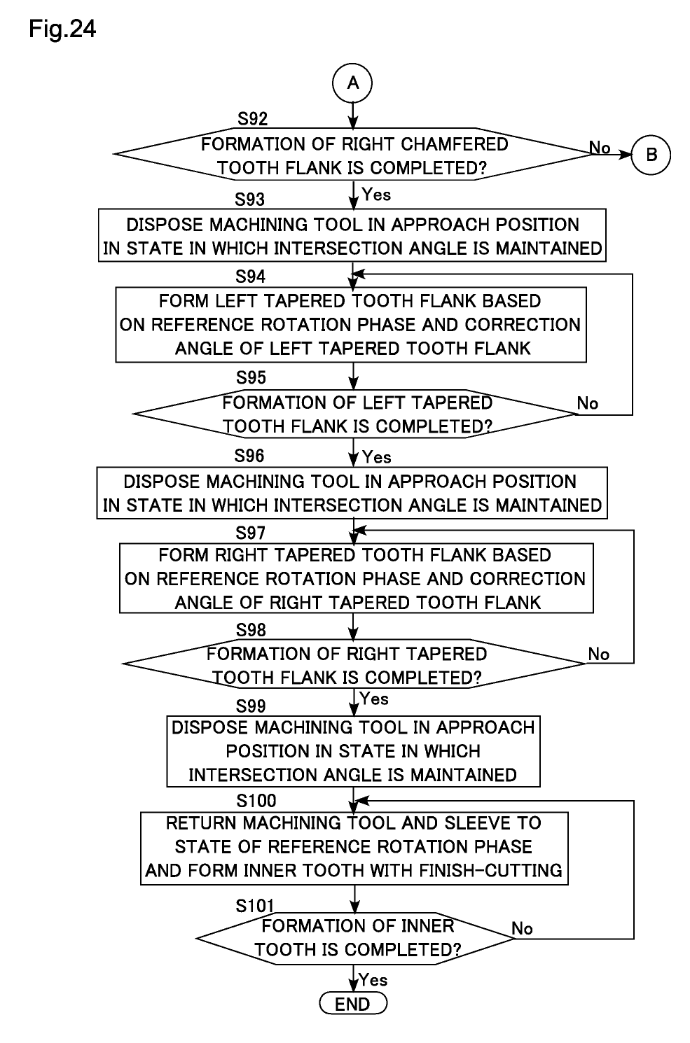

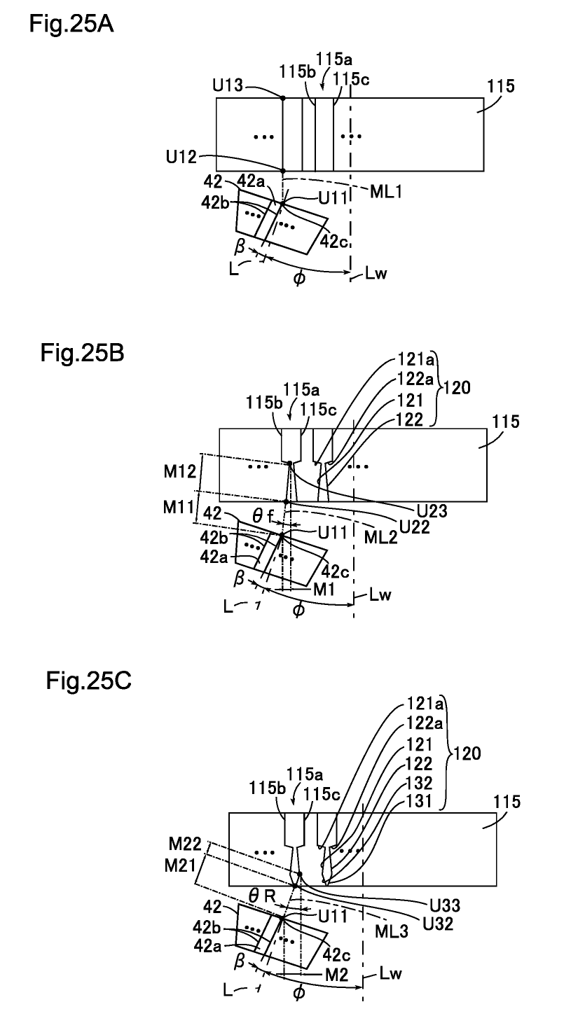

A process (a machining method) by the machining control unit 101 and the correction angle calculating unit 104 of the control device 200 is described with reference to FIGS. 23 and 24. It is assumed here that the operator manufactures the machining tool 42 based on the shape data of the machining tool 42 designed by the tool design unit 102. It is assumed that the machining tool 42 is attached to the rotary spindle 40 of the machining device 1 and the sleeve 115 is attached to the workpiece holder 80 of the machining device 1.

The torsion angles θf and θr of the tapered tooth flanks 121 and 122, the torsion angles θL and θR of the chamfered tooth flanks 131 and 132, and a sum of a first distance from an approach position U11 of the tapered tooth flanks 121 and 122 to a cutting start position and a second distance from the cutting start position to a cutting completion position are assumed to be stored in advance in the memory 105. In the following description, description of the tooth grooves 115g, 121g, 122g, 131g, and 132g is omitted. Only the tooth flanks 115b, 115c, 121, 122, 131, and 132 are described.

The correction angle calculating unit 104 of the control device 200 calculates the correction angles σf, σr, σL, and σR in cutting the tapered tooth flanks 121 and 122 and the chamfered tooth flanks 131 and 132 and stores the correction angles σf, σr, σL, and σR in the memory 105 (step S81 in FIG. 23; equivalent to “calculating step” of the invention). The machining control unit 101 sets the intersection angle ϕ to a predetermined value (step S82 in FIG. 23; equivalent to “setting step” of the invention) and disposes the machining tool 42 in the approach position U11 (step S83 in FIG. 23).

The machining control unit 101 feeds the machining tool 42 in the direction of the rotation axis Lw of the sleeve 115 once or a plurality of times while rotating the machining tool 42 synchronously with the sleeve 115. The machining control unit 101 roughly cuts the inner circumference of the sleeve 115 to form the left tooth flank 115b and the right tooth flank 115c of the inner tooth 115a. Further, the machining control unit 101 intermediately finish-cuts the formed left tooth flank 115b and the formed right tooth flank 115c of the inner tooth 115a (step S84 in FIG. 23; equivalent to “first cutting step” of the invention). The intermediate finish-cutting is performed by setting tool feeding speed lower than tool feeding speed during the rough cutting. By the intermediate finish-cutting, as illustrated in FIG. 18A, burrs B1 are formed at end portions on a cutting end side of the machining tool 42 in the left tooth flank 115b and the right tooth flank 115c of the inner tooth 115a.

When the cutting of the left tooth flank 115b and the right tooth flank 115c of the inner tooth 115a is completed (step S85 in FIG. 23), the machining control unit 101 stores a rotation phase of the machining tool 42 and the sleeve 115 at this time in the memory 105 as a reference rotation phase (step S86 in FIG. 23; equivalent to “storing step” of the invention). The machining control unit 101 disposes the machining tool 42 in the approach position U11 in a state in which the intersection angle ϕ is maintained (step S87 in FIG. 23).

The machining control unit 101 feeds the machining tool 42 in the direction of the rotation axis Lw of the sleeve 115 once or a plurality of times while rotating the machining tool 42 synchronously with the sleeve 115 based on the reference rotation phase and the correction angle σL, of the left chamfered tooth flank 131. The machining control unit 101 cuts the inner tooth 115a to form the left chamfered tooth flank 131 on the left tooth flank 115b of the inner tooth 115a (step S88 in FIG. 23; equivalent to “second cutting step” of the invention). When the cutting of the left chamfered tooth flank 131 is completed (step S89 in FIG. 23), the machining control unit 101 disposes the machining tool 42 in the approach position U11 in a state in which the intersection angle ϕ is maintained (step S90 in FIG. 23).

The machining control unit 101 feeds the machining tool 42 in the direction of the rotation axis Lw of the sleeve 115 once or a plurality of times while rotating the machining tool 42 synchronously with the sleeve 115 based on the reference rotation phase and the correction angle σR of the right chamfered tooth flank 132. The machining control unit 101 cuts the right tooth flank 115c of the inner tooth 115a to form the right chamfered tooth flank 132 on the right tooth flank 115c of the inner tooth 115a (step S91 in FIG. 23; equivalent to “second cutting step” of the invention). The machining control unit 101 may cut the left chamfered tooth flank 131 after cutting the right chamfered tooth flank 132. By the cutting, as illustrated in FIG. 18B, burrs B2 are formed at end portions on a cutting end side of the machining tool 42 in the left chamfered tooth flank 131 and at end portions on a cutting end side of the machining tool 42 in the right chamfered tooth flank 132.

When the cutting of the right chamfered tooth flank 132 is completed (step S92 in FIG. 24), the machining control unit 101 disposes the machining tool 42 in the approach position U11 in a state in which the intersection angle ϕ is maintained (step S93 in FIG. 24). The machining control unit 101 feeds the machining tool 42 once or a plurality of times in the direction of the rotation axis Lw of the sleeve 115 while rotating the machining tool 42 synchronously with the sleeve 115 based on the reference rotation phase and the correction angle σf of the left tapered tooth flank 121. The machining control unit 101 cuts the inner tooth 115a to form the left tapered tooth flank 121 including the left sub-tooth flank 121a (step S94 in FIG. 24; equivalent to “second cutting step” of the invention).

That is, as illustrated in FIGS. 19A to 19C, the machining tool 42 performs a cutting operation in the direction of the rotation axis Lw of the sleeve 115 once or a plurality of times to form the left tapered tooth flank 121 including the left sub-tooth flank 121a in the inner tooth 115a. The machining tool 42 at this time needs to perform a feeding operation and a returning operation in the opposite direction from the feeding operation. However, as illustrated in FIG. 19C, an inertial force acts in this reversing operation. Therefore, the feeding operation of the machining tool 42 ends at a point Q, which is shorter by a predetermined length than the tooth trace length ff of the left tapered tooth flank 121 that can form the left tapered tooth flank 121 including the left sub-tooth flank 121a, and shifts to the returning operation. The feed end point Q can be calculated by measurement with a sensor or the like. However, if the feeding amount is sufficiently accurate with respect to necessary machining accuracy, the point Q can be adjusted by the feeding amount without being measured. That is, accurate machining can be achieved by performing cutting work while adjusting the feeding amount such that machining can be performed up to the point Q.

When the cutting of the left tapered tooth flank 121 is completed (step S95 in FIG. 24), the machining control unit 101 disposes the machining tool 42 in the approach position U11 in a state in which the intersection angle ϕ is maintained (step S96 in FIG. 24). The machining control unit 101 feeds the machining tool 42 in the direction of the rotation axis Lw of the sleeve 115 once or a plurality of times while rotating the machining tool 42 synchronously with the sleeve 115 based on the reference rotation phase and the correction angle σr of the right tapered tooth flank 122. The machining control unit 101 cuts the inner tooth 115a to form the right tapered tooth flank 122 including the right sub-tooth flank 122a by cutting (step S97 in FIG. 24; equivalent to “second cutting step” of the invention).

The machining control unit 101 may cut the left tapered tooth flank 121 after cutting the right tapered tooth flank 122. By the cutting, as illustrated in FIG. 18C, the burrs B2 formed on the left chamfered tooth flank 131 and the right chamfered tooth flank 132 are removed and burrs B3 are formed at end portions on a cutting end side of the machining tool 42 in the left tapered tooth flank 121 and the right tapered tooth flank 122.

When the cutting of the right tapered tooth flank 122 is completed (step S98 in FIG. 24), the machining control unit 101 disposes the machining tool 42 in the approach position U11 in a state in which the intersection angle ϕ is maintained (step S99 in FIG. 24). The machining control unit 101 feeds the machining tool 42 in the direction of the rotation axis Lw of the sleeve 115 once while returning the machining tool 42 and the sleeve 115 to the state of the reference rotation phase and rotating the machining tool 42 synchronously with the sleeve 115. The machining control unit 101 finish-cuts the left tooth flank 115b and the right tooth flank 115c of the inner tooth 115a (step S100 in FIG. 24). The finish-cutting is performed by setting tool feeding speed lower than tool feeding speed during the intermediate finish-cutting.

When the finish-cutting of the left tooth flank 115b and the right tooth flank 115c of the inner tooth 115a is completed (step S101 in FIG. 24), the machining control unit 101 ends the entire process. By the finish-cutting, as illustrated in FIG. 18D, the burrs B1 formed on the left tooth flank 115b and the right tooth flank 115c of the inner tooth 115a and the burrs B3 formed on the left tapered tooth flank 121 and the right tapered tooth flank 122 are removed. Although burrs are formed even after the finish-cutting, because the burrs are extremely small, the burrs can be removed by a post-process (e.g., brushing).

As described above, in the machining device 1, first, the groove 115g between the left tooth flank 115b and the right tooth flank 115c of the sleeve 115 is roughly cut and intermediately finish-cut. Subsequently, a groove 131g between the left chamfered tooth flank 131 and the right chamfered tooth flank 132 of the gear coming-off preventing section 120 is cut. Subsequently, the groove 121g between the left tapered tooth flank 121 and the right tapered tooth flank 122 of the gear coming-off preventing section 120 is cut. Finally, the groove 115g between the left tooth flank 115b and the right tooth flank 115c of the inner tooth 115a of the sleeve 115 is finish-cut. Consequently, all the tooth flanks 115b, 115c, 121, 122, 131, and 132 can be machined by only cutting in which tool replacement and phase matching of the machining tool 42 and the workpiece W are unnecessary. Further, burrs formed in the cuttings can be removed in order. In particular, burrs formed last can be removed by finish-cutting. Therefore, it is possible to more greatly reduce a machining time than in the past.

If the left tapered tooth flank 121 and the right tapered tooth flank 122 are cut and then the left chamfered tooth flank 131 and the right chamfered tooth flank 132 are cut, the following problems occur. That is, in the finish-cutting, there is no chance of bringing the inner tooth 115a into contact with the left chamfered tooth flank 131 and the right chamfered tooth flank 132. Therefore, burrs formed in the left chamfered tooth flank 131 and the right chamfered tooth flank 132 cannot be removed. As described above, the gear coming-off preventing section 120 can be formed by only cutting and formed burrs can be removed simultaneously with the cutting. Therefore, it is possible to more greatly reduce a machining time of the rolling, the end milling, and the punching than in the past.

### 2-8. Others

In the example described above, the machining tool 42 is designed to be adapted to the cutting of the left tooth flank 115b and the right tooth flank 115c of the inner tooth 115a. The machining tool 42 is not adapted to the cutting of the left tapered tooth flank 121, the right tapered tooth flank 122, the left chamfered tooth flank 131, and the right chamfered tooth flank 132 of the gear coming-off preventing section 120. Therefore, the machining tool 42 is adapted to the cutting using the correction angles σf, σr σL, and σR. However, when the machining tool 42 is designed to be adapted to the cutting of any one of the left tapered tooth flank 121, the right tapered tooth flank 122, the left chamfered tooth flank 131, and the right chamfered tooth flank 132, the machining tool 42 can be adapted to the remaining cuttings using the correction angles.

In the example described above, the tooth groove 115g, the tapered tooth groove 121g, and the chamfered tooth groove 131g are machined. However, the machining is not particularly limited to the tooth grooves. Any grooves can be machined in the same manner. In the example described above, the machining is performed on the inner circumferential tooth of the internal gear. However, the machining can also be performed on an outer circumferential tooth of an external gear. The workpiece is the sleeve 115 of the synchromesh mechanism 110. However, the workpiece may be a workpiece including a tooth section that meshes like a gear, a cylindrical workpiece, or a disk-shaped workpiece. A plurality of tooth flanks (having a different plurality of tooth traces or tooth shapes (tooth tips and tooth roots)) can be machined in the same manner on one or both of the inner circumference (the inner tooth) and the outer circumference (the outer tooth). Continuously changing tooth traces and tooth shapes (tooth tips and tooth roots) such as crowning and relieving can also be machined in the same manner. Meshing can be optimized (performed in a satisfactory state).

In the example described above, the machining device 1, which is a five-axis machining center, is capable of turning the sleeve 115 about the A axis. On the other hand, the five-axis machining center may be configured as a vertical machining center to be capable of turning the machining tool 42 about the A axis. In the above description, the invention is applied to the machining center. However, the invention can also be applied to a machine specific for gear machining. In the above description, the machining of the tooth bottom of the gear is described as the example. However, the invention is applicable to machining of a groove of a circumferential surface of a general cylindrical workpiece.

In the example described above, the one machining tool 42 is adapted to the cutting of the six machining parts, that is, the left tooth flank 115b and the right tooth flank 115c of the inner tooth 115a of the workpiece (the sleeve 115) and the left tapered tooth flank 121, the right tapered tooth flank 122, the left chamfered tooth flank 131, and the right chamfered tooth flank 132 of the gear coming-off preventing section 120. However, when the width of the tooth grooves 115g (the left tooth flanks 115b and the right tooth flanks 115c) of the adjacent inner teeth 115a of the workpiece (the sleeve 115) is narrow, when the torsion angles of the left tapered tooth flank 121 and the right tapered tooth flank 122 are large, or when the torsion angles of the left chamfered tooth flank 131 and the right chamfered tooth flank 132 are large, the machining tool 42 and the workpiece (the sleeve 115) sometimes interfere with each other. In such a case, the interference can be prevented by performing machining using a plurality of machining tools 42.

For example, it is assumed that, as illustrated in FIG. 27B, a torsion angle θf1 of the left tapered tooth flank 121 and a torsion angle θr1 of the right tapered tooth flank 122 are the same and a torsion angle θL1 of the left chamfered tooth flank 131 and a torsion angle θR1 of the right chamfered tooth flank 132 are the same. In this case, the left tapered tooth flank 121 and the right tapered tooth flank 122 can be machined by setting the rotation phase of the machining tool 42 and the sleeve 115 during the synchronous rotation to correction angles σf1 and σr1 with respect to the reference rotation phase (0 degree) in a state in which the intersection angle ϕ is kept fixed in the machining tool 42 having the same torsion angle β1. The left chamfered tooth flank 131 and the right chamfered tooth flank 132 can be machined by setting the rotation phase of the machining tool 42 and the sleeve 115 during the synchronous rotation to correction angles σL1 and σR1 with respect to the reference rotation phase (0 degree) in a state in which the intersection angle ϕ is kept fixed in the machining tool 42 having the same torsion angle β2.

In this way, the number of machining tools 42 can be set to three with respect to the six machining parts. Therefore, it is possible to reduce a frequency of tool replacement. It is possible to reduce a machining time and reduce tool expenses. The intersection angle can be fixed to ϕ with respect to the six machining parts. Therefore, readjustment of a machining position (a phase, etc.) of the machining tool 42 is unnecessary. It is possible to reduce the machining time. The correction angles σf1, σr1, σL1, and σR1, which can be easily adjusted, only have to be changed. Therefore, it is possible to reduce the machining time.

For example, it is assumed that, as illustrated in FIG. 27C, the torsion angle θf1 of the left tapered tooth flank 121 and the torsion angle θr1 of the right tapered tooth flank 122 are different and the torsion angle θL1 of the left chamfered tooth flank 131 and the torsion angle θR1 of the right chamfered tooth flank 132 are different. In this case, the left tapered tooth flank 121, the right tapered tooth flank 122, the left chamfered tooth flank 131, and the right chamfered tooth flank 132 can be machined by setting the rotation phase of the machining tool 42 and the sleeve 115 during the synchronous rotation to correction angles σf2, σr2, σL2, and σR2 with respect to the reference rotation phase (0 degree) in a state in which the intersection angle ϕ is kept fixed in the machining tool 42 having different torsion angles β3, β4, β5, and β6.

In this way, the intersection angle can be fixed to ϕ with respect to the six machining parts. Therefore, readjustment of a machining position (a phase, etc.) of the machining tool 42 is unnecessary. It is possible to reduce a machining time. The correction angles σf2, σr2, σL2, and σR2, which can be easily adjusted, only have to be changed. Therefore, it is possible to reduce the machining time. In some case, it is possible to reduce a tool replacement frequency by partially changing intersection angles in machining processes (types of tooth flanks). It is possible to reduce the machining time.

What is claimed is:

1. A machining device comprising a control device configured to use a machining tool having a rotation axis, an intersection angle of which can be changed with respect to a rotation axis of a workpiece and cut a peripheral surface of the workpiece by feeding the machining tool relatively in a direction of the rotation axis of the workpiece while rotating the machining tool synchronously with the workpiece, wherein
the peripheral surface of the workpiece includes at least a first groove and a second groove having torsion angles different from each other, and
the control device changes the intersection angle based on the torsion angles to respectively cut the first groove and the second groove.

2. The machining device according to claim 1, wherein
a tooth of a gear having both side wall sections of the first groove or the second groove as tooth flanks is formed on the peripheral surface of the workpiece,
a side surface on one side of the tooth of the gear includes a first tooth flank, a second tooth flank having a torsion angle different from a torsion angle of the first tooth flank, and a third tooth flank having a torsion angle different from the torsion angles of the first tooth flank and the second tooth flank and formed to extend to the second tooth flank further on an end surface side of the tooth of the gear than the second tooth flank,
a side surface on another side of the tooth of the gear includes a fourth tooth flank, a fifth tooth flank having a torsion angle different from a torsion angle of the fourth tooth flank, and a sixth tooth flank having a torsion angle different from the torsion angles of the fourth tooth flank and the fifth tooth flank and formed to extend to the fifth tooth flank further on an end surface side of the tool of the gear than the fifth tooth flank, and
the control device first sets the intersection angle to a first intersection angle to at least roughly cut the first tooth flank and the fourth tooth flank, subsequently changes the intersection angle to a second intersection angle to machine the third tooth flank and changes the intersection angle to a third intersection angle to cut the sixth tooth flank, subsequently changes the intersection angle to a fourth intersection angle to machine the second tooth flank and changes the intersection angle to a fifth intersection angle to cut the fifth tooth flank, and finally changes the intersection angle to the first intersection angle to finish-cut the first tooth flank and the fourth tooth flank.

3. The machining device according to claim 2, wherein
the machining device includes a first machining tool, a second machining tool, and a third machining tool as the machining tool,
a blade trace of a cutting blade of the first machining tool has a torsion angle set based on the torsion angles of the first tooth flank, the second tooth flank, the fourth tooth flank, and the fifth tooth flank and the first intersection angle, the fourth intersection angle, and the fifth intersection angle to be capable of cutting first tooth flank and cutting the second tooth flank with respect to the first tooth flank and capable of cutting the fourth tooth flank and cutting the fifth tooth flank with respect to the fourth tooth flank,
a blade trace of a cutting blade of the second machining tool has a torsion angle set based on the torsion angle of the third tooth flank and the second intersection angle to be capable of cutting the third tooth flank with respect to the first tooth flank, and
a blade trace of a cutting blade of the third machining tool has a torsion angle set based on the torsion angle of the sixth tooth flank and the third intersection angle to be capable of cutting the sixth tooth flank with respect to the fourth tooth flank.

4. The machining device according to claim 2, wherein
a blade trace of a cutting blade of the machining tool has a torsion angle set based on the torsion angles of the first tooth flank, the second tooth flank, the fourth tooth flank, and the fifth tooth flank to be capable of cutting the first tooth flank and cutting the second tooth flank with respect to the first tooth flank and capable of cutting the fourth tooth flank and cutting the fifth tooth flank with respect to the fourth tooth flank and the intersection angle, and
the intersection angle is set based on the torsion angle of the blade trace of the cutting blade of the machining tool, the torsion angle of the third tooth flank, and the torsion angle of the sixth tooth flank.

5. The machining device according to claim 2, wherein
the gear is a sleeve of a synchromesh mechanism, and
the second tooth flank, the third tooth flank, the fifth tooth flank, and the sixth tooth flank are tooth flanks of a gear coming-off preventing section provided in an inner circumferential tooth of the sleeve.

6. The machining device according to claim 1, wherein
the machining tool has a torsion angle of a blade trace of a cutting blade of the machining tool corresponding to a torsion angle of the first groove or the second groove to be capable of cutting the first groove or the second groove, and
the control device includes:
a correction angle calculating unit configured to calculate, concerning each of the first groove and the second groove, a correction angle with respect to a rotation phase of the workpiece based on a distance reaching a cutting completion position from an approach position of the cutting of the first groove or the second groove through a cutting start position and the torsion angle of the first groove or the second groove; and
a machining control unit configured to set an intersection angle of a rotation axis of the workpiece and a rotation axis of the machining tool to a predetermined value, control synchronous rotation of the machining tool and the workpiece to be shifted by the correction angle of the first groove or the second groove, and cut the first groove or the second groove.

7. The machining device according to claim 6, wherein the machining control unit stores, as a reference rotation phase, a rotation phase of the machining tool and the workpiece during the synchronous rotation when cutting the first groove or the second groove, controls the synchronous rotation of the machining tool and the workpiece to be shifted by the correction angle of the remaining first or second groove with respect to the reference rotation phase, and cuts the first groove or the second groove.

8. The machining device according to claim 6, wherein a machining target of the machining device is an inner circumferential tooth of an internal gear or an outer circumferential tooth of an external gear.

9. The machining device according to claim 8, wherein the first groove or the second groove is a tooth groove of the inner circumferential tooth or a tooth groove of the outer circumferential tooth, and the remaining first or second groove is a tapered tooth flank formed in the inner circumferential tooth or the outer circumferential tooth.

10. The machining device according to claim 8, wherein the first groove or the second groove is a tooth groove of the inner circumferential tooth or a tooth groove of the outer circumferential tooth, and the remaining first or second groove is a chamfered tooth flank formed in the inner circumferential tooth or the outer circumferential tooth.

11. A machining method for using a machining tool having a rotation axis, an intersection angle of which can be changed with respect to a rotation axis of a workpiece, and cutting a peripheral surface of the workpiece by feeding the machining tool relatively in a direction of the rotation axis of the workpiece while rotating the machining tool synchronously with the workpiece,
a tooth of a gear having both side wall sections of a first groove and a second groove as tooth flanks being formed on the peripheral surface of the workpiece, and aside surface on one side of the tooth of the gear including a first tooth flank, a second tooth flank having a torsion angle different from a torsion angle of the first tooth flank, and a third tooth flank having a torsion angle different from the torsion angles of the first tooth flank and the second tooth flank and formed to extend to the second tooth flank further on an end surface side of the tooth of the gear than the second tooth flank,
a side surface on another side of the tooth of the gear including a fourth tooth flank, a fifth tooth flank having a torsion angle different from a torsion angle of the fourth tooth flank, and a sixth tooth flank having a torsion angle different from the torsion angles of the fourth tooth flank and the fifth tooth flank and formed to extend to the fifth tooth flank further on the end surface side of the tooth of the gear than the fifth tooth flank,
the machining method comprising:
a first step of first setting the intersection angle to a first intersection angle to at least roughly cut the first tooth flank and the fourth tooth flank;
a second step of subsequently changing the intersection angle to a second intersection angle to machine the third tooth flank and changing the intersection angle to a third intersection angle to cut the sixth tooth flank;
a third step of subsequently changing the intersection angle to a fourth intersection angle to machine the second tooth flank and changing the intersection angle to a fifth intersection angle to cut the fifth tooth flank; and
a fourth step of finally changing the intersection angle to the first intersection angle to finish the first tooth flank and the fourth tooth flank.

12. A machining method for using a machining tool having a rotation axis inclined with respect to a rotation axis of a workpiece and cutting a peripheral surface of the workpiece by feeding the machining tool relatively in a direction of the rotation axis of the workpiece while rotating the machining tool synchronously with the workpiece,
the peripheral surface of the workpiece including at least a first groove and a second groove having torsion angles different from each other, and
the machining tool having a torsion angle of a blade trace of a cutting blade of the machining tool corresponding to the torsion angle of the first groove or the second groove to be capable of cutting the first groove or the second groove,
the machining method comprising:
a calculating step for calculating, concerning each of the first groove and the second groove, a correction angle with respect to a rotation phase of the workpiece based on a distance reaching a cutting completion position from an approach position of the cutting of the first groove or the second groove through a cutting start position and the torsion angle of the first groove or the second groove;
a setting step for setting an intersection angle of a rotation axis of the workpiece and a rotation axis of the machining tool to a predetermined value;
a first cutting step for controlling synchronous rotation of the machining tool and the workpiece to be shifted by the correction angle of the first groove or the second groove and cutting the first groove or the second groove;
a storing step for storing, as a reference rotation phase, a rotation phase of the machining tool and the workpiece during the synchronous rotation at this time; and
a second cutting step for controlling the synchronous rotation of the machining tool and the workpiece to be shifted by the correction angle of the remaining first or second groove with respect to the reference rotation phase and cutting the remaining first groove or the second groove.
